(19) United States
(12) Patent Application Publication
(10) Pub. No.: US 2017/0262196 A1
(43) Pub. Date: Sep. 14, 2017

(54) LOAD MONITORING METHOD AND INFORMATION PROCESSING APPARATUS

(71) Applicant: FUJITSU LIMITED, Kawasaki-shi (JP)

(72) Inventor: ATSUHITO HIROSE, Odawara (JP)

(73) Assignee: FUJITSU LIMITED, Kawasaki-shi (JP)

(21) Appl. No.: 15/434,111

(22) Filed: Feb. 16, 2017

(30) Foreign Application Priority Data
Mar. 10, 2016 (JP) 2016-046923

(51) Int. Cl. G06F 3/06

(52) U.S. Cl. CPC G06F 3/0617; G06F 3/0647; G06F 3/0653; G06F 3/0631; G06F 3/067

(57) ABSTRACT

A non-transitory computer-readable recording medium stores a load monitoring program that causes a first information processing apparatus to execute a process. The process comprises transmitting, receiving and determining. The transmitting includes transmitting a processing request to a second information processing apparatus including a storage unit. The receiving includes receiving a processing result containing a data size of the storage unit, the data size of the storage unit being calculated by the second information processing apparatus. The determining includes determining whether the data size, contained in the received processing result, of the storage unit exceeds a predetermined size.

### CROSS-REFERENCE TO RELATED APPLICATION

This application is based upon and claims the benefit of priority of the prior Japanese Patent Application No. 2016-046923, filed on Mar. 10, 2016, the entire contents of which are incorporated herein by reference.

### FIELD

The embodiments discussed herein are related to a load monitoring method and an information processing apparatus.

### BACKGROUND

In recent years, a data size processed by an information system has been increased, a scale-up of the information system and an introduction of cloud computing have been accelerated. With the increased data size processed by the information system, there occur processing requests beyond a presumption at a stage of designing the information system, in which case the information reallocates the data within the information system or distributes loads through an extension of servers included by the information system, and by other equivalent schemes.

Known as a method of reallocating the data is a technology (e.g., Patent document 1 or 2) of changing a storage location of the data, corresponding to an access frequency. Further, a scale-out is known as a method of extending the servers included by the information system. The scale-out is the method of enabling the servers to be extended without interrupting processes on the servers.

### DOCUMENTS OF PRIOR ARTS

### Patent Document

[Patent document 1] Japanese Laid-open Patent Publication No. H06-139119

[Patent document 2] Japanese Laid-open Patent Publication No. 2009-288979

### SUMMARY

According to an aspect of the embodiments, a non-transitory computer-readable recording medium stores a load monitoring program that causes a first information processing apparatus to execute a process. The process comprises transmitting, receiving and determining. The transmitting includes transmitting a processing request to a second information processing apparatus including a storage unit. The receiving includes receiving a processing result containing a data size of the storage unit, the data size of the storage unit being calculated by the second information processing apparatus. The determining includes determining whether the data size, contained in the received processing result, of the storage unit exceeds a predetermined size.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is an explanatory diagram of a monitoring load on a management server;

FIG. 2 is an explanatory diagram of a delay of detecting an overload by the management server;

FIG. 3 is a diagram illustrating an example of an architecture of an information processing system;

FIG. 4 is a diagram illustrating one example of a hardware configuration of an information processing apparatus;

FIG. 5 is a diagram illustrating one example of components of a server apparatus;

FIG. 6 is a diagram illustrating one example of components of a client apparatus;

FIG. 7 is a diagram illustrating one example of a data structure of a partition layout list;

FIG. 8 is a diagram illustrating one example of a data structure of a partition list;

FIG. 9 is a diagram illustrating one example of migration data;

FIG. 10 is a diagram illustrating an example of a definition file of the server apparatus;

FIG. 11 is a diagram illustrating one example of a data structure of a partition information list;

FIG. 12 is a diagram illustrating one example of a data structure of a server destination address list;

FIG. 13 is a diagram illustrating one example of a data structure of a standby server list;

FIG. 14 is a diagram illustrating one example of processing request data;

FIG. 15 is a diagram illustrating one example of processing result data;

FIG. 16 is a diagram illustrating an operational example of a process of detecting an overload on the server apparatus;

FIG. 17 is a diagram illustrating an operational example of a scale-out process;

FIG. 18 is a diagram illustrating a specific example of the scale-out process;

FIG. 19 is a diagram illustrating an operational example of the server apparatus receiving the processing request after the scale-out;

FIG. 20 is a diagram illustrating an operational example of a process of updating a data capacity of the migration data, corresponding to a variation at a migration destination;

FIG. 21 is a diagram illustrating an operational example of a scale-out cancel process;

FIG. 22 is a diagram illustrating an operational example of the server apparatus receiving the processing request after canceling the scale-out;

FIG. 23 is a flowchart illustrating an example in which the client apparatus monitors the load on the server apparatus;

FIG. 24 is a flowchart illustrating an example of a case where the server apparatus receives the processing request from the client apparatus;

FIG. 25 is a flowchart illustrating an example of a scale-out process for the server apparatus;

FIG. 26 is a flowchart illustrating an example of a scale-out cancel process for the server apparatus; and

FIG. 27 is a flowchart illustrating an example of such a process that the server apparatus monitors a load on the self apparatus.

### DESCRIPTION OF EMBODIMENTS

The loads on the servers within the information system are detected in such a way that, e.g., a management server periodically collects performance information of the servers by monitoring the respective servers. When the processing requests from clients or other servers (which will hereinafter be also called other information processing apparatuses) within the information system are abruptly concentrated due to an almost unpredictable factor, the servers get into an overload state as the case may be. It is desirable that the overloads on the servers are detected timely without any delay of time to the greatest possible degree. Such a possibility rises that the overloads on the servers are timely detected by increasing a monitoring frequency of each server. However, the increase in monitoring frequency brings about a rise in size of data flowing to a network and an increase in usage rate of a Central Processing Unit (C PU).

An embodiment will hereinafter be described based on the drawings. A configuration of the following embodiment is an exemplification, and the present invention is not limited to the configuration of the embodiment.

### COMPARATIVE EXAMPLE

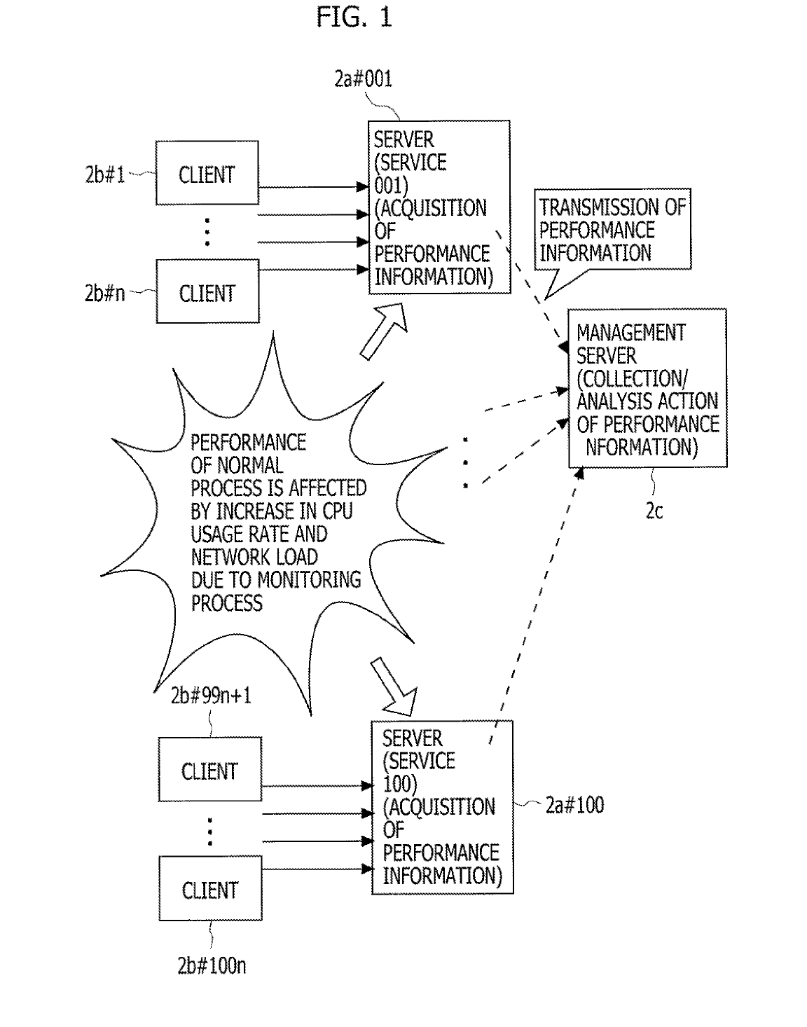

FIG. 1 is an explanatory diagram of a monitoring load of a management server. The management server 2c is a server that monitors performances of servers 2a#001-2a#100. The servers 2a#001-2a#100 are generically termed the servers (also called server apparatuses) 2a. The management server 2c collects performance information from the servers 2a. The management server 2c executes a process of analyzing the performance information collected from the servers 2a.

The server 2a#001 accepts processing requests from clients 2b#1-2b#n. A service 001 is a process that is executed by the server 2a#001 based on the processing requests given from the clients 2b#1-2b#n. The server 2a#001 accepts the processing requests from clients 2b#99n+1-2b#100n. A service 100 is a process that is executed by the server 2a#100 based on the processing requests given from the clients 2b#99n+1-2b#100n. The clients 2b#1-2b#n and the clients 2b#99n+1-2b#100n are generically termed clients (also called client apparatuses) 2b.

The servers 2a implement the service 001 and the service 100 respectively based on the processing requests given from the clients 2b, and may each implement a plurality of services. The servers 2a may acquire and transmit the performance information per service to the management server 2c by implementing the plurality of services.

The servers 2a acquire the performance information of the servers 2a, based on a request given from the management server 2c. The performance information is instanced by periods of response time to the processing requests from the clients 2b, execution time of the processing, a data size and other equivalent information of the data stored in an auxiliary storage device and other equivalent storages. The servers 2a transmit the acquired performance information to the management server 2c.

When monitoring the performance of the servers 2a for the purpose of timely detecting overloads of the servers 2a, a collecting interval of the performance information from the management server 2c to the servers 2a is shortened, and consequently a collecting frequency of the performance information rises. When the collecting frequency of the performance information with respect to the servers 2a rises, CPU usage rates of the servers 2a increase. The increases in CPU usage rates affect periods of implementation time of the service 001, the service 100 and other equivalent services (which will hereinafter be simply termed the services 001, 100). Further, a load on a network increases due to a rise in transmission frequency of the performance information, and this affects periods of response time of the services 001, 100. The loads on the servers 2a also rise concomitantly with the rise in monitoring frequency at which the management server 2c monitors the servers 2a.

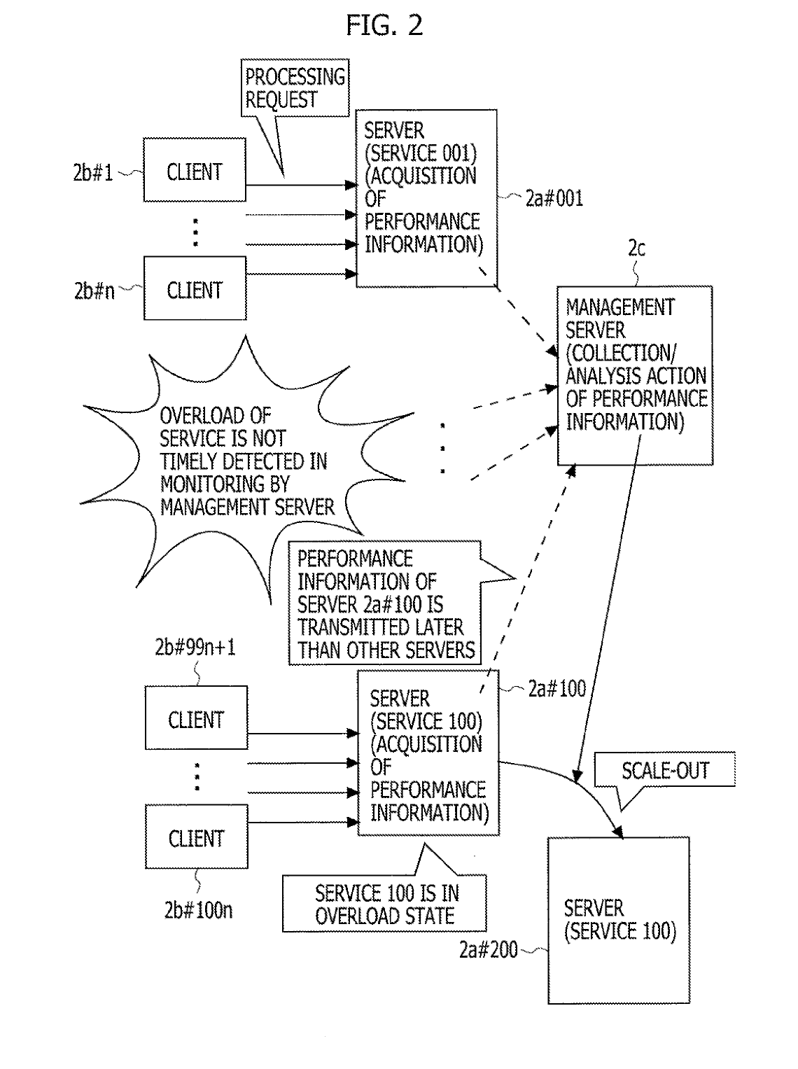

FIG. 2 is an explanatory diagram of a delay with which the management server 2c detects the overload. The management server 2c, e.g., when the data size of a data storage area of the server 2a exceeds a predetermined size, determines that this server 2a is in an overload state. The management server 2c may also determine whether in the overload state by monitoring the data size per service implemented by the server 2a.

The management server 2c, similarly to FIG. 1, collects the performance information from the servers 2a. The servers 2a transmit the collected performance information to the management server 2c. In an example of FIG. 2, the management server 2c detects from the collected performance information that the service 100 is in the overload state. The management server 2c executes a scale-out for the server 2a#100, thereby migrating the service 100 to the server 2a#200. The scale-out is a process of migrating the service to another server 2a. The scale-out reduces the load on the migration source server 2a#100.

In the example of FIG. 2, the management server 2c, similarly to FIG. 1, collects the performance information from the servers 2a. The servers 2a transmit the collected performance information to the management server 2c. The management server 2c, upon detecting the overload on the service 100, scaling out the service 100 to the server 2a#200.

Herein, the performance information from the servers 2a is sequentially transmitted to the management server 2c at every monitoring interval of the management server 2c. Accordingly, even when the service 100 of the server 2a#100 comes to the overload state, the performance information from the server 2a#100 is transmitted to the management server 2c later than other servers 2a, in which case the detection of the overload is delayed. The delay of detecting the overload disables the service 100 from being timely scaled out (migrated) to the server 2a#200. Therefore, such a case arises that the server 2a#100 fails in accepting the processing request from the client 2b due to a decline in performance.

### Embodiment

According to the embodiment, the server apparatus 2a, upon receiving the processing request from the client apparatus 2b, performs an operation based on the processing request. The server apparatus 2a calculates the data size of the data storage area after performing the operation. The server apparatus 2a sets data storage information containing the calculated data size in a processing result data of the performed operation, and transmits the processing result data to the client apparatus 2b. The data storage information is instanced by a data capacity, a data size, a threshold value of the data capacity, and other equivalent information of the data storage area. The data capacity is a size of the data that can be stored in the data storage area. The data size is a size of the data being stored in the data storage area. The data storage area is also simply called an area or a partition.

The client apparatus 2b determines whether the data size of the data storage area, which is contained in the processing result data received from the server apparatus 2a, exceeds a predetermined size, thereby detecting the overload on the server apparatus 2a. The client 2b, upon detecting the overload on the server 2a, instructs the server apparatus 2a to perform the scale-out. The server apparatus 2a migrates, based on the scale-out, part of the data stored in the data storage area to a migration destination server apparatus 2a.

<System Architecture and Apparatus Configuration>

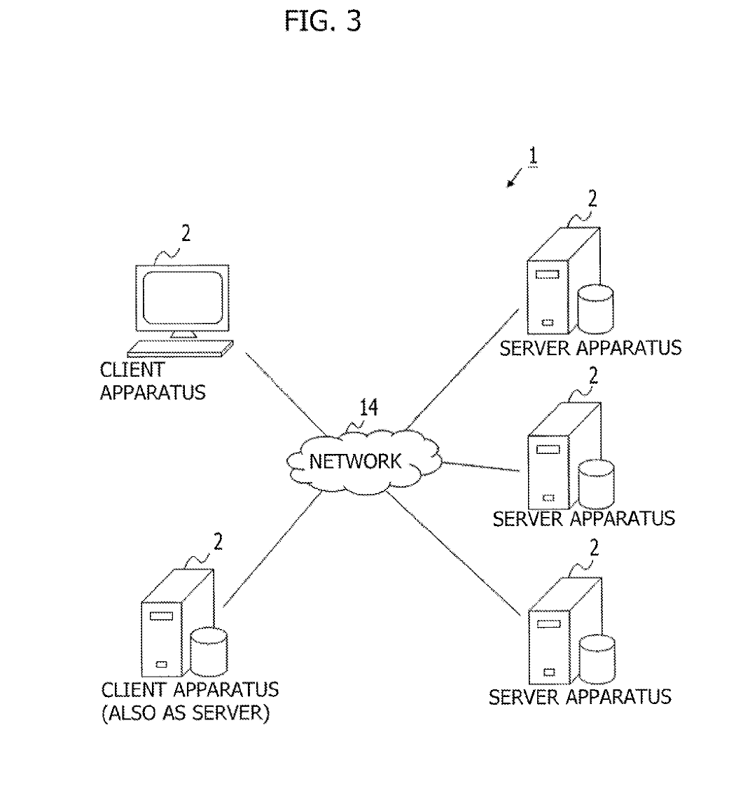

FIG. 3 is a diagram illustrating an example of an architecture of an information processing system 1. The information processing system 1 includes a plurality of information processing apparatuses 2 interconnected via a network 14. The information processing apparatus 2 is the server apparatus 2a or the client apparatus 2b, and may also be the server apparatus 2a/client apparatus 2b. The server apparatus 2a is one example of “a second information processing apparatus” and “a third information processing apparatus”. The client apparatus 2b is one example of “a first information processing apparatus”.

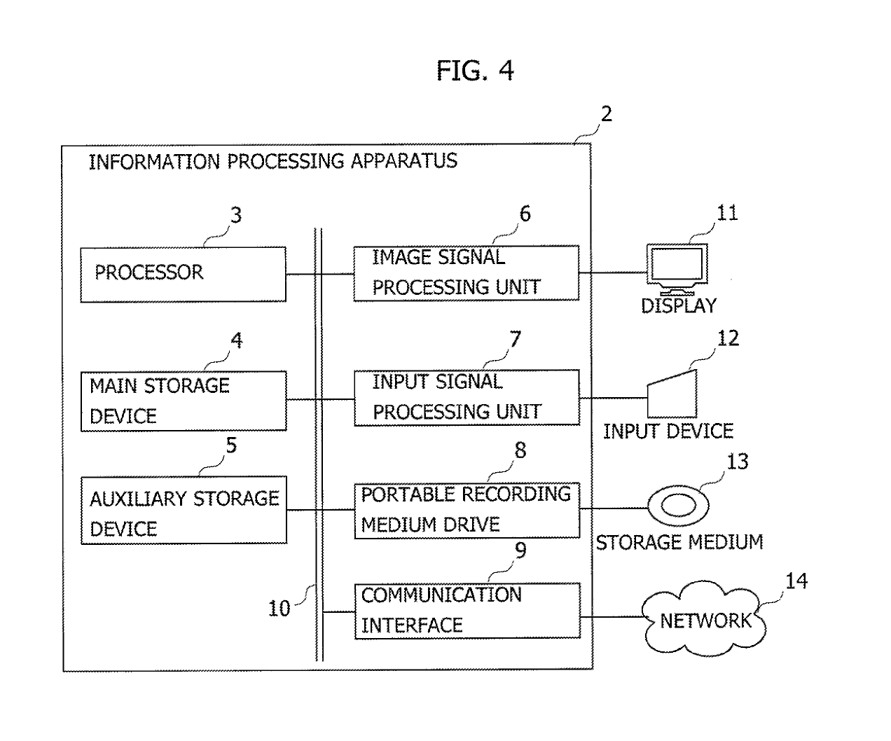

FIG. 4 is a diagram illustrating one example of a hardware configuration of the information processing apparatus 2. The information processing apparatus 2 includes a processor 3, a main storage device 4, an auxiliary storage device 5, an image signal processing unit 6, an input signal processing unit 7, a portable recording medium drive 8, and a communication interface 9. These components are interconnected via a bus 10.

The processor 3 loads an Operating System (OS) and various categories of computer programs, which are retained in the auxiliary storage device 5 or the storage medium 13, onto the main storage device 4, and runs these software components, thereby executing a variety of processes. However, part of the processes based on the computer programs may also be executed by hardware circuits. The processor 3 is also called a CPU. The processor 3 may also be a Digital Signal Processor (DSP). The processor 3 may further be a multicore processor including a plurality of cores and a multiprocessor including an assembly of a plurality of CPUs.

The main storage device 4 provides the processor 3 with a storage area for loading the programs stored in the auxiliary storage device 5 and a work area for running the programs. The main storage device 4 is used as a buffer for retaining the data. The main storage device 4 is a semiconductor memory instanced by a Read Only Memory (ROM) and a Random Access Memory (RAM).

The auxiliary storage storage 5 stores the various categories of programs and the data used by the processor 3 when running the programs. The auxiliary storage storage 5 is a nonvolatile memory instanced by an Erasable Programmable ROM (EPROM) or a Hard Disk Drive (HDD). The auxiliary storage storage 5 retains, e.g., the OS and other various application programs.

The image signal processing unit 6 converts the processing result of the processor 3 into image signals, and outputs the image signals to, e.g., a display 11. The input signal processing unit 7 outputs input signals inputted from an input device 12 to the processor 3. The input device 12 is a pointing device instanced by a keyboard and a mouse.

The portable recording medium drive 8 reads and outputs the programs and various items of data recorded on a storage medium 13 to the processor 3. The storage medium 13 is a recording medium instanced by a Solid State (SD) card, a mini SD card, a micro SD card, a Universal Serial Bus (USB) flash memory, a Compact Disc (CD), a Digital Versatile Disc (DVD) and a flash memory card.

The communication interface 9 is an interface that inputs and outputs the information from and to the network 14. The communication interface 9 includes an interface connected to a wired network and an interface connected to a wireless network. The communication interface 9 is instanced by a Network Interface Card (NIC), and a wireless Local Area Network (LAN) card. The data and other equivalent information received by the communication interface 9 are outputted to the processor 3.

For example, in the information processing apparatus 2, the processor 3 loads a load monitoring program retained on the auxiliary storage storage 5 onto the main storage device 4, and runs this load monitoring program. Note that the apparatus configuration of the information processing apparatus 2 is one example, and the components can be properly omitted, replaced and added corresponding to the embodiment without being limited to the configuration described above. The load monitoring program may also be recorded on, e.g., the storage medium 13.

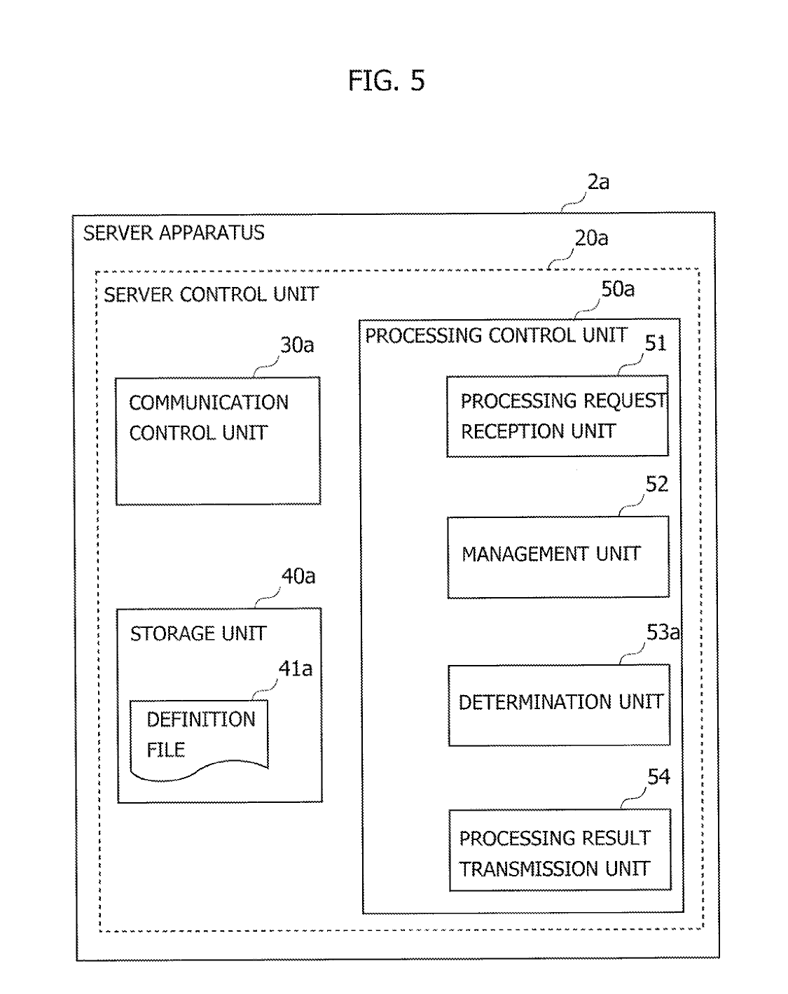

FIG. 5 is a diagram illustrating one example of components of the server apparatus 2a. The server apparatus 2a includes a server control unit 20a. The server control unit 20a includes a communication control unit 30a, a storage unit 40a and a processing control unit 50a.

The processor 3 of the server apparatus 2a executes, based on the computer programs, processes of the communication control unit 30a, the storage unit 40a, and processes of a processing request reception unit 51, a management unit 52, a determination unit 53a and a processing result transmission unit 54 that are included by the processing control unit 50a. However, any one or part of the processes of these components may also be executed by the hardware circuits.

The communication control unit 30a controls the communications with other information processing apparatuses 2 within the information processing system 1 via the network 14. The storage unit 40a is a data storage area for storing the data used for the processes of the processing control unit 50a. The data stored in the storage unit 40a can be stored on the auxiliary storage storage 5. The storage unit 40a includes a definition file 41a. The definition file 41a stores values of definition parameters on a server side, which are used for the processes of the processing control unit 50a.

The processing control unit 50a includes the processing request reception unit 51, the management unit 52, the determination unit 53a and the processing result transmission unit 54. The processing request reception unit 51 receives the processing request from the client apparatus 2b, and performs the operation based on the processing request.

The management unit 52 manages the data storage information instanced by the data capacity and the data size. The management unit 52 segments the storage unit 40a into a plurality of partitions, and may manage the data storage information on a partition-by-partition basis. To be specific, the management unit 52, after performing the operation based on the processing request given from the client apparatus 2b, calculates a data size of the partition containing operation target data. The management unit 52, when the data size of the partition exceeds a predetermined size, expands the data capacity of the partition.

The determination unit 53a determines whether the data size of the storage unit 40a, which is calculated by the management unit 52, exceeds the predetermined size. The determination unit 53a may also determine whether the data size of the storage unit 40a exceeds the predetermined size by checking whether the data size of the storage unit 40a exceeds a predetermined rate, e.g., 90% to the data capacity of the storage unit 40a. When the storage unit 40a contains the plurality of partitions, it may be sufficient to determine whether the data size of the partition containing the operation target data exceeds the predetermined size. The data size of any one of the plurality of partitions exceeds the predetermined size, in which case also the determination unit 53a determines that the server apparatus 2a is in the overload state.

The processing result transmission unit 54 generates a result of the operation based on the processing request given from the client apparatus 2b as processing result data. The processing result transmission unit 54 sets the data storage information containing the data size of the storage unit 40a, which is calculated by the management unit 52, in the processing result data, and transmits the processing result data to the client apparatus 2b.

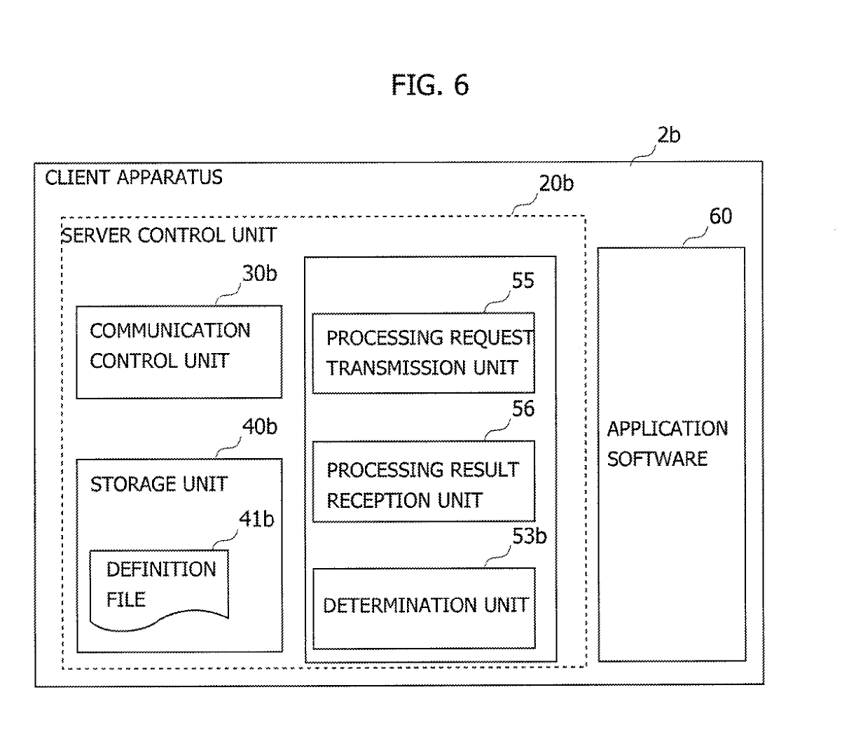

FIG. 6 is a diagram illustrating one example of the components of the client apparatus 2b. The client apparatus 2b includes a client control unit 20b and application software 60. The client control unit 20b includes a communication control unit 30b, a storage unit 40b and a processing control unit 50b.

The processor 3 of the client apparatus 2b executes, based on the computer programs, processes of the communication control unit 30b and the storage unit 40b, and also processes of a processing request transmission unit 55, a processing result reception unit 56 and a determination unit 53b that are included by the processing control unit 50b. However, any one or part of the processes of these components may also be executed by the hardware circuits.

The communication control unit 30b controls the communications with other information processing apparatuses 2 within the information processing system 1 via the network 14. The storage unit 40b stores the data used for the processes of the processing control unit 50b. The data stored in the storage unit 40b can be stored on the auxiliary storage storage 5. The storage unit 40b includes a definition file 41b. The definition file 41b stores values of definition parameters on a client side, which are used for the processes of the processing control unit 50b.

The processing control unit 50b includes a processing request transmission unit 55, a processing result reception unit 56 and a determination unit 53b. The processing request transmission unit 55, upon receiving the processing request for, the application software 60, transmits the processing request to the server apparatus 2a based on the received processing request.

The processing result reception unit 56 receives a processing result data in response to the transmitted processing request from the server apparatus 2a. The processing result data contains the data storage information of the storage unit 40a of the server apparatus 2a. The determination unit 53b determines whether the data size of the storage unit 40a, which is contained in the processing result data, exceeds the predetermined size.

<Data Structure>

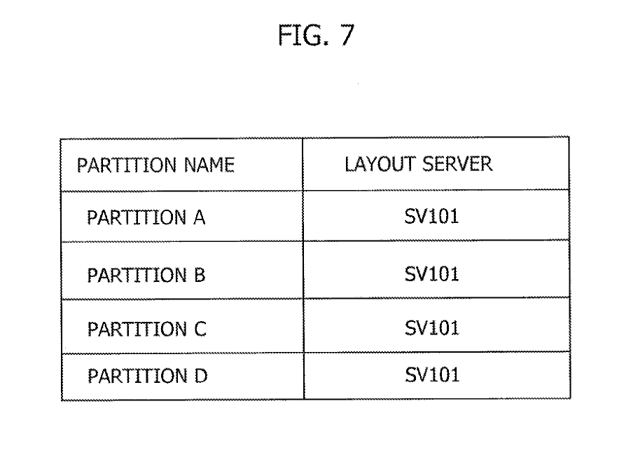

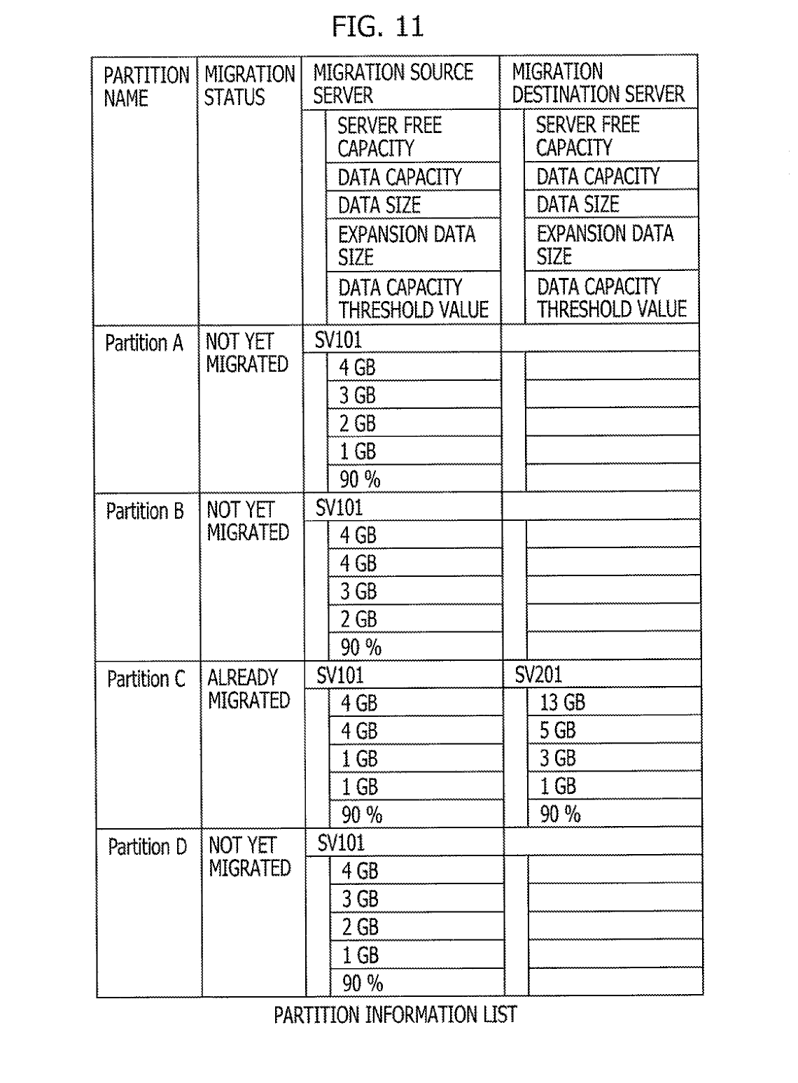

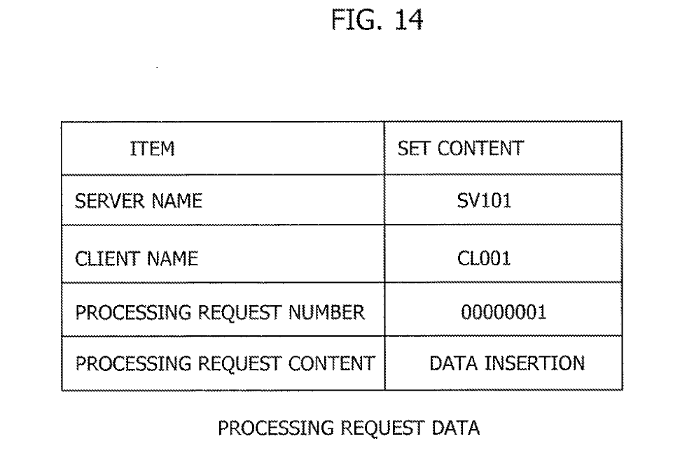

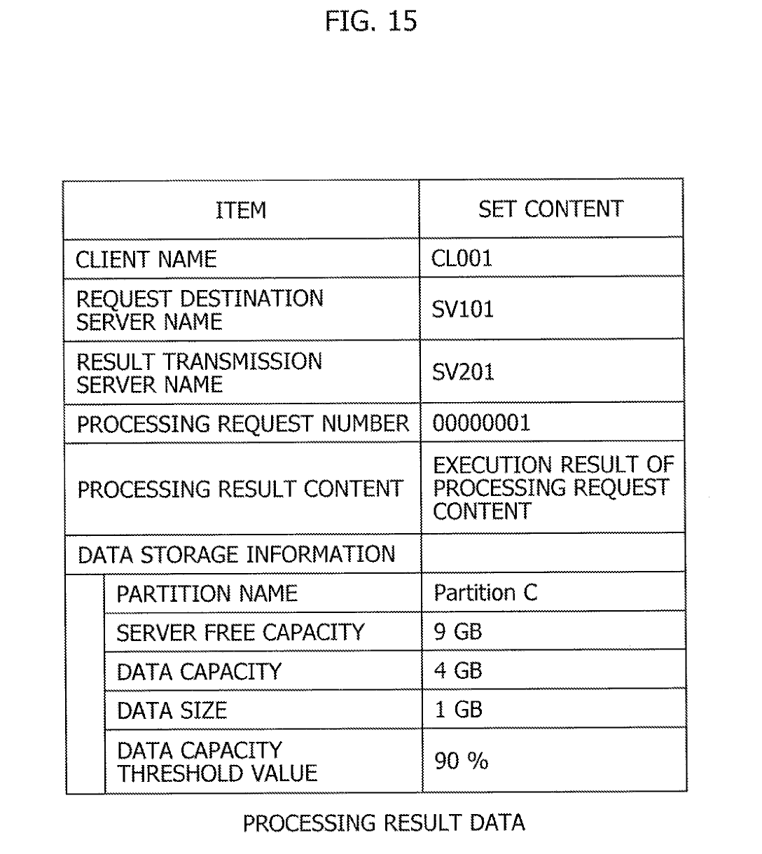

FIGS. 7 through 10 explanatorily illustrate examples of data definitions and data structures of the data used in the respective server apparatuses 2a. FIGS. 11 through 13 explanatorily illustrate examples of data definitions and data structures of the data used in the respective client apparatuses 2b. FIGS. 14 and 15 explanatorily illustrate examples of data structures of the processing request data and the processing result data, which are transmitted and received between the server apparatus 2a and the client apparatus 2b.

FIG. 7 is the diagram illustrating one example of a data structure of a partition layout list. The partition layout list is a list for defining a layout of the partitions. The partition is a unit area for the management of the data that migrates to the migration destination server, and is an area of the predetermined data capacity. The partition layout definition defines the server apparatus 2a in which the partitions are laid out. The partition layout list is stored in, e.g., the auxiliary storage storage 5 of the server apparatus 2a. In FIG. 7, the partition layout definition contains, by way of one example, a “partition name” field and a “layout server” field.

The “partition name” field indicates a name of the partition. For example, “Partition A”, “Partition B” and other partition names are set in the “partition name” field. The “layout server” field indicates the server apparatus 2a in which to lay out the partitions. In the example of FIG. 7, values “SV101” are set as the layout servers of the Partitions A-D. In other words, the Partitions A-D are laid out in “SV101”.

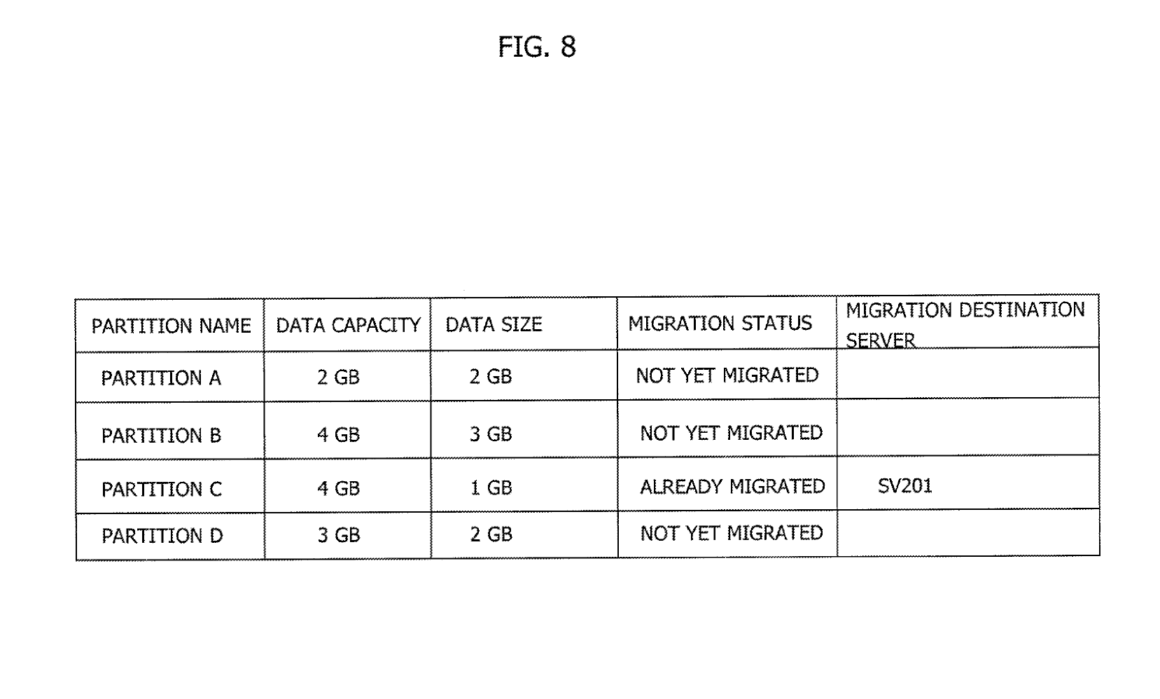

FIG. 8 is a diagram illustrating one example of a data structure of a partition list. The partition list is a list of the partitions managed by the server apparatus 2a. The partition list stores items of information such as a partition migration status, a migration destination server and other equivalent items. The partition list is stored in, e.g., the auxiliary storage storage 5 of the server apparatus 2a.

The partition list contains a “partition name” field, a “data capacity” field, a “data size” field, a “migration status” field, and a “migration destination server” field. The “partition name” field indicates a name of the partition managed by the server apparatus 2a. The “data capacity” field indicates a capacity of the data that can be stored in the partition. The “data size” field indicates a size of the data that are currently stored in the partition. The “migration status” field indicates a status of whether the partition is scaled out to the migration destination server apparatus 2a. The “migration destination server” field indicates the server apparatus 2a in which the already-migrated partition exists.

The server apparatus 2a, when executing the process in response to the processing request given from the client apparatus 2b, updates the data size of the operation target partition. The server apparatus 2a, when the data size of the partition exceeds the predetermined size, expands the data capacity of the partition. In this case, the server apparatus 2a updates a value in the “data capacity” field of the partition list.

In FIG. 8, with respect to, e.g., “Partition A” a value “2 GB” is set in the “data capacity” field, a value “2 GB” is set in the “data size” field, and a value “not yet migrated” is set in the “migration status” field. With respect to “Partition C”, “4 GB” is set in the “data capacity” field, “1 GB” is set in the “data size” field, “already migrated” is set in the “migration status” field, and “SV201” is set in the “migration destination server” field.

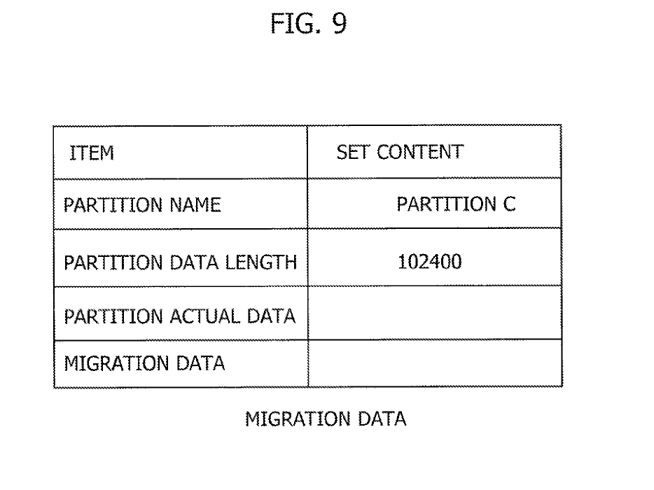

FIG. 9 is a diagram illustrating one example of migration data. The migration data defines the data migrated to the migration destination server by the scale-out from the server apparatus 2a from which the overload is detected. The data, which are to be migrated to the migration destination server, are migrated on, e.g., the partition-by-partition basis. The migration data contains a “partition name” field, a “partition data length” field, and a “partition actual data” field.

The “partition name” field indicates a name of the migration target partition, and “Partition C” is set in this “partition name” field in the example of FIG. 9. The “partition data length” field indicates a data length of the “Partition C” as the migration target partition, and “102400” is set in this “partition data length” field. The “partition actual data” field indicates actual data of the “Partition C” as the migration target partition.

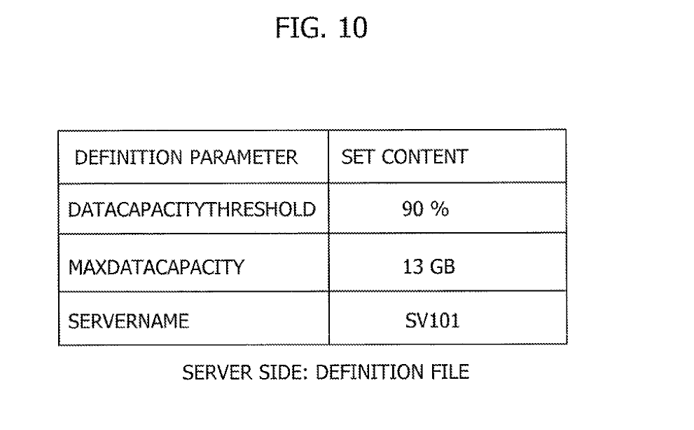

FIG. 10 is a diagram illustrating an example of a definition file 41a of the server apparatus 2a. The definition file 41a of the server apparatus 2a is stored in, e.g., the auxiliary storage storage 5 of the server apparatus 2a. The definition file 41a of the server apparatus 2a defines a parameter “DataCapacityThreshold”, a parameter “MaxDataCapacity” and a parameter “ServerName”.

The parameter “DataCapacityThreshold” is a threshold value of the data size (which will hereinafter be referred to also as a threshold value of the data capacity) with respect to the data capacity of the server apparatus 2a, and “90%” is set in the “DataCapacityThreshold” in the example of FIG. 10. In this case, when the data size stored in the storage unit 40a of the server apparatus 2a exceeds 90% of the data capacity of the storage unit 40a, the server apparatus 2a is determined to be in the overload state and is thereby scaled out.

Note that the server apparatus 2a may also determine whether in the overload state by applying the threshold value of the data capacity defined by the“DataCapacityThreshold” on the partition-by-partition basis, which is contained in the storage unit 40a. A threshold value that differs on the partition-by-partition basis may also be defined as the threshold value of the data capacity.

The parameter “MaxDataCapacity” is a data storage capacity of the storage unit 40a, and “13 GB” is set in this parameter “MaxDataCapacity”. The parameter “ServerName” is an Internet Protocol (IP) destination address or a machine name of the self server apparatus 2a, and a machine name “SV101” is set in this “ServerName”.

FIG. 11 is a diagram illustrating one example of a data structure of a partition information list. The partition information list stores information of the partition in which the client apparatus 2b retains the operation target data. The partition information is information of the server apparatus 2a in which the data are allocated, and is also called data allocation information. The partition information list is stored in, e.g., the auxiliary storage storage 5 of the client apparatus 2b.

The partition information list contains a“partition name” field, a “migration status” field, a “migration source server” field, and a “migration destination server” field. The “partition name” field indicates a name of the partition in which the client apparatus 2b retains the operation target data. The “migration status” field indicates a status of whether the partition is migrated to the migration destination server apparatus 2a from the migration source server apparatus 2a by the scale-out. The “migration source server” field stores information of the migration source server apparatus 2a in which to lay out the partition. The “migration destination server” field stores information of the migration destination server apparatus 2a when performing the scale-out upon detecting the overload on the migration source server.

Each of the “migration source server” field and the “migration destination server” field contains a “server free capacity” field, a “data capacity” field, a “data size” field, an “expansion data size” field, and a “data capacity threshold value” field. The “server free capacity” field indicates a data capacity of a free area of the storage unit 40a. The server free capacity can be calculated as a data capacity obtained by subtracting a sum of the data capacities of the respective partitions from the overall data capacity of the storage unit 40a. The data capacity is a capacity of the data that can be stored in the partition. The “data size” field indicates a size of the data stored in the partition. The “expansion data size” field indicates a data capacity to be expanded when the data size of the partition exceeds the predetermined size. The “data capacity threshold value” field indicates a data capacity threshold value for determining whether the partition is in the overload state.

The client apparatus 2b, when receiving the processing result data in response to the processing request transmitted to the server apparatus 2a, updates the values of the respective fields of the migration source server based on the data storage information contained in the processing result data. The client apparatus 2b, when the partition is migrated to another server apparatus 2a by the scale-out of the server apparatus 2a, updates the values of the respective fields of the migration destination server in this partition.

In FIG. 11, for example, the “Partition C” is in the “already migrated” status to the migration destination server “SV201” from the migration source server “SV101”. A data free area of the migration source server “SV101” is “4 GB”. The data capacity, the data size and the expansion data size of the“Partition C” are “4 GB”, “1 GB” and “1 GB”, respectively. The data capacity threshold value of the “Partition C” is “90%”.

It is assumed that the migration source server “SV101”, upon receiving a scale-out instruction from the client apparatus 2, will have migrated the “Partition C” to the migration destination server “SV201”. The data free area of the migration destination server “SV201” is “13 GB”. The data free area has some allowance, and hence the data capacity of the “Partition C” is expanded by 1 GB into “5 GB”. The data is inserted into the “Partition C” by executing the process for the “Partition C”, in which case the data size becomes, e.g., “3 GB”. In the migration destination server “SV201”, there is no change in threshold value of each of the expansion data size and the data capacity.

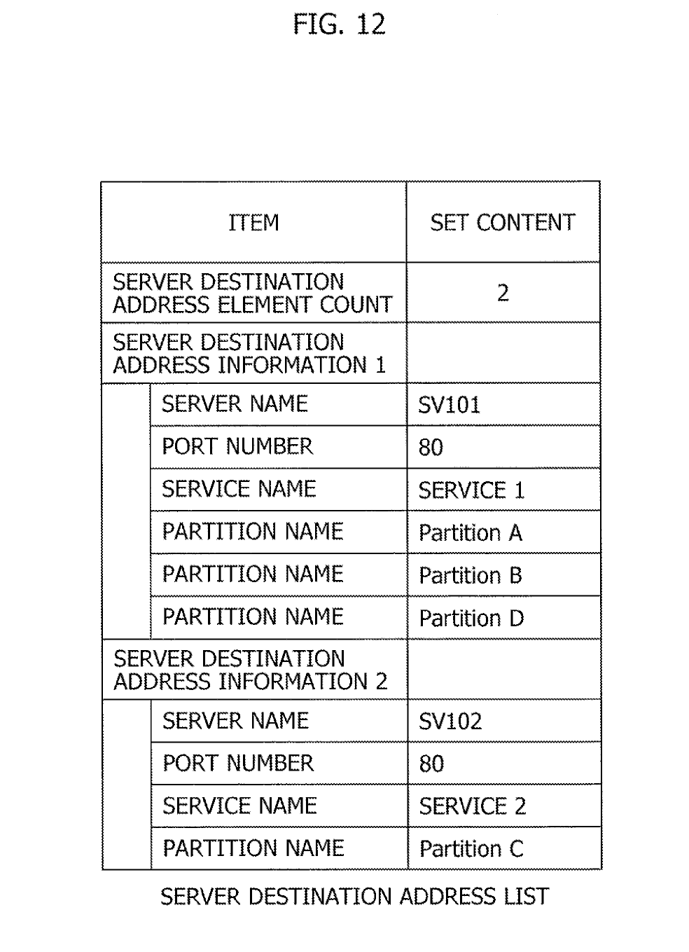

FIG. 12 is a diagram illustrating one example of a data structure of a server destination address list. The server destination address list stores information of the server apparatus 2a connected from the client apparatus 2b. The server destination address list is stored in, e.g., the auxiliary storage storage 5 of the client apparatus 2b.

The server destination address list contains a “server destination address element count” field. The “server destination address element count” field indicates a number of the server apparatuses 2a connected from the client apparatuses 2b. The server destination address list stores a number of sets of server destination address information, which number is set in the “server destination address element count” field.

The server destination address information contains a “server name” field, a “port number” field, a “service name” field, and a “partition name” field. The “server name” field indicates an IP address or a machine name of the server apparatus 2a connected from the client apparatus 2b. The “port number” field indicates a port number for connecting to the server apparatus 2a concerned. The “service name” field indicates an identifier for identifying a scale-out target service. The “partition name” field indicates a name of the partition used for the scale-out target service. A plurality of partitions may also be available as the scale-out target services. In the case of using the plurality of partitions, there are stored the partition names, of which the number corresponds to the number of partitions for use.

In the example of FIG. 12, the server destination address element count is “2”, and two sets of server destination address information are stored. For example, “SV101”, “80” and “SERVICE 1” are set respectively as the server name, the port number and the service name of the server destination address information 1. Further, three partition names “Partition A”, “Partition B” and “Partition D” used by the service named “SERVICE 1” are set as the partition names.

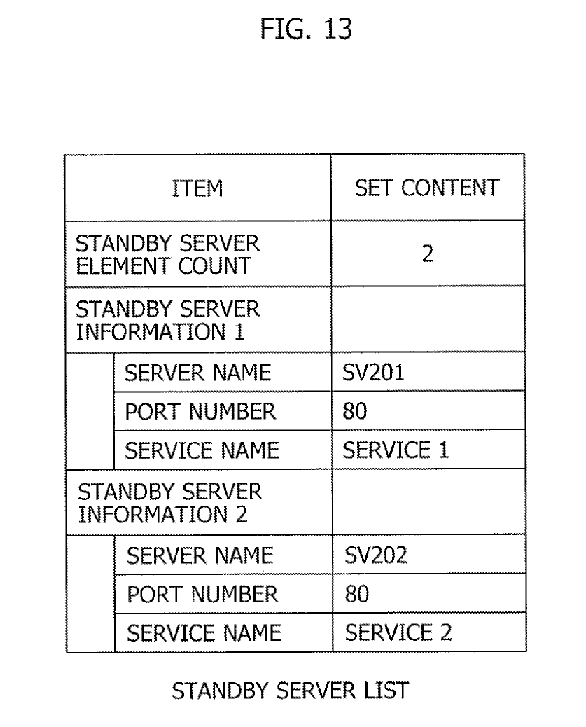

FIG. 13 is a diagram illustrating one example of a data structure of a standby server list. The standby server is a server apparatus 2a used as a data migration destination server by the scale-out when detecting the overload on the active server apparatus 2a. The standby server list is stored in, e.g., auxiliary storage storage 5 of the client apparatus 2b.

Incidentally, such a case exists that the information processing system 1 is prepared with a backup site, for a countermeasure against a disaster, enabling each service to be implemented as a substitute. In this case, the server apparatus 2a from which the overload is detected may divert, to the standby server, the server apparatus 2a acting as the substitute to implement the same service as the overloaded server apparatus 2a implements within the backup site.

The standby server list contains a “standby server element count” field. The “standby server element count” field indicates a number of the server apparatuses 2a prepared as the standby servers. The standby server list stores information of the standby servers, of which a number is set in the “standby server element count” field.

A “standby server information” field further contains a “server name” field, a “port number” field, and a “service name” field. The “server name” field indicates an IP address or a machine name of the migration destination server apparatus 2a based on the scale-out. The “port number” field indicates a port number for connecting to the migration destination server apparatus 2a. The “service name” field indicates an identifier for identifying the scale-out target service. A plurality of scale-out target services may also be available. In other words, one standby server may also be used as the migration destination server apparatus 2a for the plurality of services.

In the example of FIG. 13, the standby server element count is “2”, and two sets of standby server information are stored. For example, “SV201”, “80” and “SERVICE 1” are set as the server name, the port number and the service name of the standby server information 1.

The client apparatus 2b selects the migration destination server apparatus 2a from the standby server list. In this case, the client apparatus 2b acquires the service name associated with the server apparatus 2a containing the migration target partition from the server destination address list. The client apparatus 2b selects the standby server associated with the acquired service name as the migration destination server apparatus 2a.

For example, it is assumed in FIG. 12 that the client apparatus 2b scales out the “Partition C”. The server “SV102” containing the “Partition C” implements the service “SERVICE 2”. In the standby server list of FIG. 13, the server associated with the service “SERVICE 2” is “SV202”. Accordingly, the client apparatus 2b migrates the “Partition C” to the server “SV202”.

FIG. 14 is a diagram illustrating one example of processing request data. The processing request data defines the processing request transmitted to the server apparatus 2a from the client apparatus 2b. In the example of FIG. 14, the processing request data contains a “server name” field, a “client name” field, a “processing request number” field, and a “processing request content” field.

The “server name” field indicates an IP address or a machine name of the server apparatus 2a receiving the processing request. The “client name” field indicates an IP address or a machine name of the client apparatus 2b transmitting the processing request. The “processing request number” field indicates an identifier for uniquely identifying the processing request. The “processing request content” field indicates a content of the process such as inserting or deleting the data. The client apparatus 2b sets, e.g., a statement of Structured Query Language (SQL) or a function of Call Level Interface (CLI) in the“processing request content” field, thus designating the processing request content. The client apparatus 2b may also designate an interface instanced by “JCache” and “memcached” as the processing request content of a NoSQL database management system other than Relational Database (RDB).

The fields of the processing request data are not limited to those illustrated in FIG. 14. The processing request data may contain the port numbers of the server apparatus 2a and the client apparatus 2b, and a connection ID information notified from the server when establishing the connection. The processing request data may also contain items of information such as a process ID of the application software 60 instructing the client apparatus 2b to issue the processing request, and processing request transmission time used for determining time-out, and other equivalent information. The processing request data may further contain information used for the server apparatus 2a to implement the scale-out, e.g., the information of the migration destination server apparatus 2a. The processing request data is one example of “a processing request”.

The FIG. 15 is a diagram illustrating one example of processing result data. The processing result data defines the processing result transmitted to the client apparatus 2b from the server apparatus 2a. The server apparatus 2a sets a result of the process executed based on the processing request given from the client apparatus 2b in the processing result data. In the example of FIG. 15, the processing result data contains a “client name” field, a “requester server name” field, a “result transmission server name” field, a “processing request number” field, a “processing result content” field, and a “data storage information” field.

The “client name” field indicates an IP address or a machine name of the client apparatus 2b transmitting the processing request. The “requester server name” field indicates an IP address or a machine name of the server apparatus 2a receiving the processing request from the client apparatus 2b.

The “result transmission server name” field indicates an IP address or a machine name of the server apparatus 2a transmitting the processing result data to the client apparatus 2b. When the overload is not detected from the request recipient server, the result transmission server becomes the same server apparatus 2a as the request recipient server. Whereas when the overload is detected from the request recipient server, the operation target data are migrated to another server apparatus 2a by the scale-out, the result transmission server becomes the server apparatus 2a, different from the request recipient server, to which the operation target data are migrated. The result transmission server name is different from the request recipient server name, in which case the client apparatus 2b updates information of the migration destination server of the partition associated with the migrated data in the partition information list (FIG. 11). In other words, the client apparatus 2b, based on the processing result data, recognizes that the operation target data are migrated, and updates the data layout information.

The “processing request number” field indicates an identifier for uniquely identifying the processing request. The server apparatus 2a executing the operation based on the processing request sets the processing request number, which is set in the processing request data, in the “processing request number” field of the processing result data.

The “processing result content” field indicates an execution result of the process designated as a processing request content of the processing request data. The server apparatus 2a executing the process sets, e.g., an execution result of the statement of SQL, or an output result of CLI in the “processing result content” field.

The “data storage information” field indicates information about a capacity of the partition containing the operation target data. The “data storage information” field further contains a “partition name” field, a “server free capacity” field, a “data capacity” field, a “data size” field, and a “data capacity threshold value” field.

The “partition name” field indicates a name of the partition containing the operation target data. The “server free capacity” field indicates a data free capacity of the storage unit 40a of the server apparatus 2a, which contains the partitions. The “data capacity” field indicates a capacity of the data that can be stored in the partition.

The “data size” field indicates a size of the data stored in the partition. The server apparatus 2a calculates the data size of the partition after executing the requested process, and sets the calculated value in the “data size” field.

The expansion data size is a data capacity to be expanded when the data size of the partition exceeds the predetermined size. The “data capacity threshold value” field indicates a data capacity threshold value for determining whether the partition is in the overload state.

The fields of the processing result data are not limited to those illustrated in FIG. 15. The processing result data may also contain items of information such as the port number of the client apparatus 2b, the process ID of the application software 60 instructing the client apparatus 2b to issue the processing request, and the connection ID when establishing the connection. The processing result data may also contain processing result related items of information such as time of transmitting the processing request, time of transmitting the processing result, and a processing result number for uniquely identifying the processing result. The processing result data is one example of “a processing result”.

The client apparatus 2b receiving the processing result data determines, based on the data storage information, whether the server apparatus 2a executing the process is in the overload state. In the example of FIG. 15, the client apparatus 2b determines whether the server apparatus 2a is in the overload state based on the data size of one partition as part of the storage unit 40a, and may also determine based on a data size of the whole storage unit 40a. In this case, it may be sufficient that the server apparatus 2a executing the process sets the data size of the whole storage unit 40a, the data capacity threshold value and other equivalent items as the data storage information in the processing result data.

The client apparatus 2b can manage the processing requests in the form of records of the RDB or in a Key Value Store (KVS) structure. The client apparatus 2b may also manage the processing requests not only by a file-formatted database but also by an in-memory database. The client apparatus 2b may determine that the server apparatus 2a is in the overload state when a number of the processing requests to be managed exceeds a threshold value. In this case, it may be sufficient that the server apparatus 2a executing the process sets a processing request count, a threshold value of the processing request count, and other equivalent items as the data storage information in the processing result data.

### Operational Example

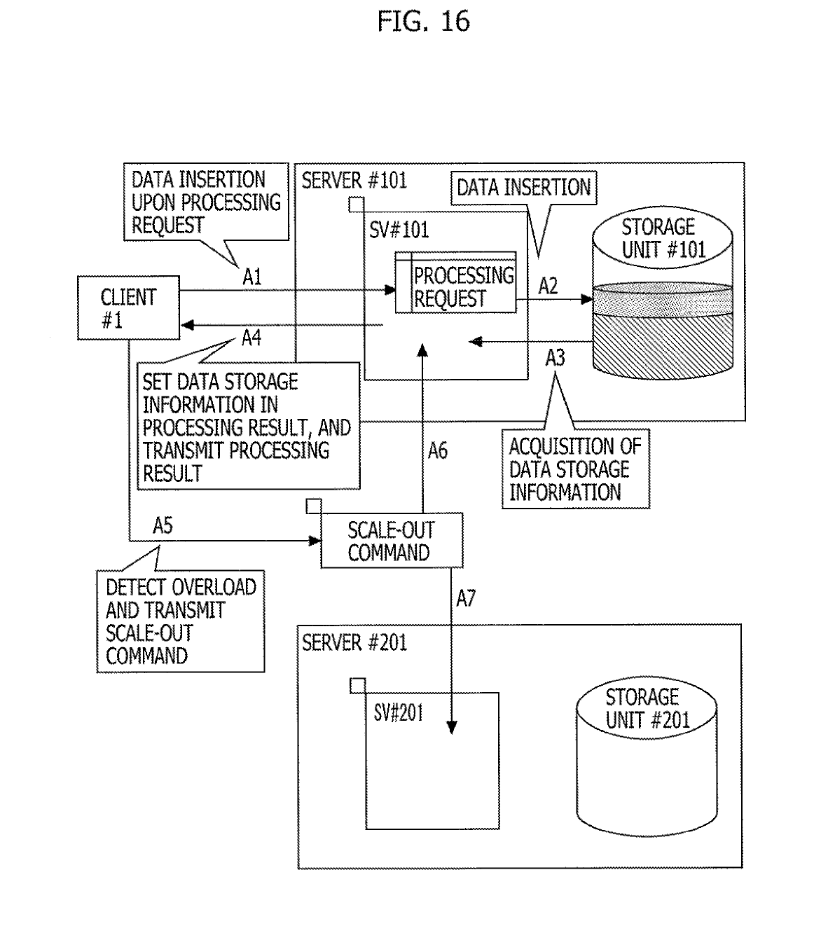

FIGS. 16 through 22 are explanatory diagrams of operational examples of the embodiment. In FIGS. 16, 17 and 19-22, the server #101 is the migration source server apparatus 2a as the scale-out target. The server #201 is the migration destination server apparatus 2a. Clients #n (n=1, 2, . . . , 6) is the client apparatus 2b. Storage units #101 and #201 are respectively the storage units 40a of the servers #101 and #201.

Note that a process executed by a Process SV#101 in the server #101 will be described on the assumption that the server #101 is an operation subject in the respective operational examples of FIGS. 16, 17 and 19-22. Similarly, a process executed by a Process SV#201 in the server #201 will be described on the assumption that the server #201 is an operation subject in every operational example.

<<Detection of Overload>>

FIG. 16 is a diagram illustrating an operational example of a process of detecting the overload on the server apparatus 2a. The client #1, when accepting the processing request involving the data insertion from the application software 60, transmits the processing request for instructing the server #101 to insert the data (A1).

The server #101 inserts the data into a storage unit #101 based on the processing request received for the client #1 (A2). The server #101 acquires the data storage information from the storage unit #101 (A3). The data storage information is information used for determining whether the data size of the storage unit #101 exceeds the predetermined size, i.e., whether the server #101 is in the overload state. The data storage information contains a data capacity that can be stored in the storage unit #101, a data size (which will hereinafter be also called a storage data size) stored in the storage unit #101, and a threshold value for determining whether the server #101 is in the overload state. The server #101 transmits the processing result data containing the data storage information being set, to the client #1 (A4).

The client #1 determines whether the server #101 is in the overload state based on the data storage information contained in the processing result data received from the server #101. The determination about whether the server #101 is in the overload state can be made depending on whether a rate of the storage data size to the data capacity that can be stored in the storage unit #101 exceeds 90%. The client #1, upon detecting the overload on the server #101, transmits a scale-out command to the server #101 and the server #201 (A5). The server #101 as the migration source server and the server #201 as the migration destination server receive the scale-out command (A6, A7).

<<Scale-Out Process>>

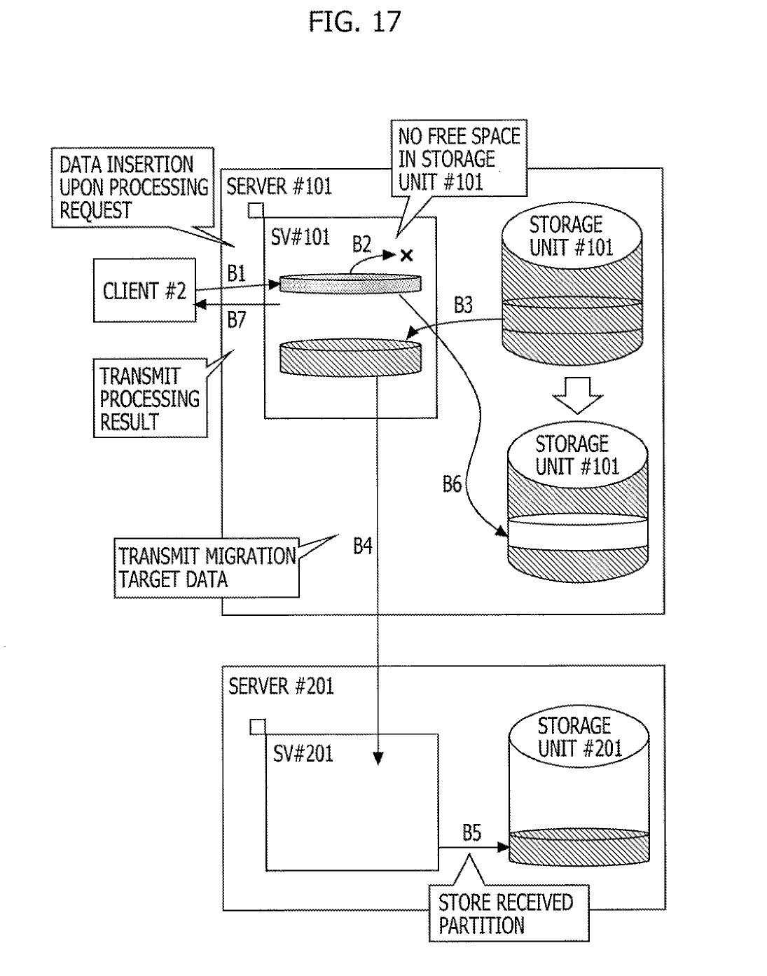

FIG. 17 is a diagram illustrating an operational example of a scale-out process. The server #101 receives the scale-out command, and starts the scale-out process when a data write process occurs in response to the processing request given from the client #2.

The server #101 receives the processing request involving the data insertion from the client #2 (B1). The storage unit #101 has no free space, and hence the data based on the processing request are disabled from being inserted into the storage unit #101 (B2).

The server #101 migrates part of the data of the storage unit #101 to the server #201 in order to ensure the free area in the storage unit #101. The server #101 extracts the data for migration to the server #201 from the storage unit #101 (B3). The migration target data may be of one partition, and may also be of a combination of plural partitions.

The server #101 transmits the migration target data to the migration destination server #201 (B4). The server #201 stores the migration target data in the storage unit #201. The scale-out process is thereby finished.

The free area is ensured in the storage unit #101 owing to the scale-out process, and the server #101 inserts the data based on the processing request into the storage unit #101 (B6). The server #101 transmits a processing result of the data insertion to the client #2 (B7).

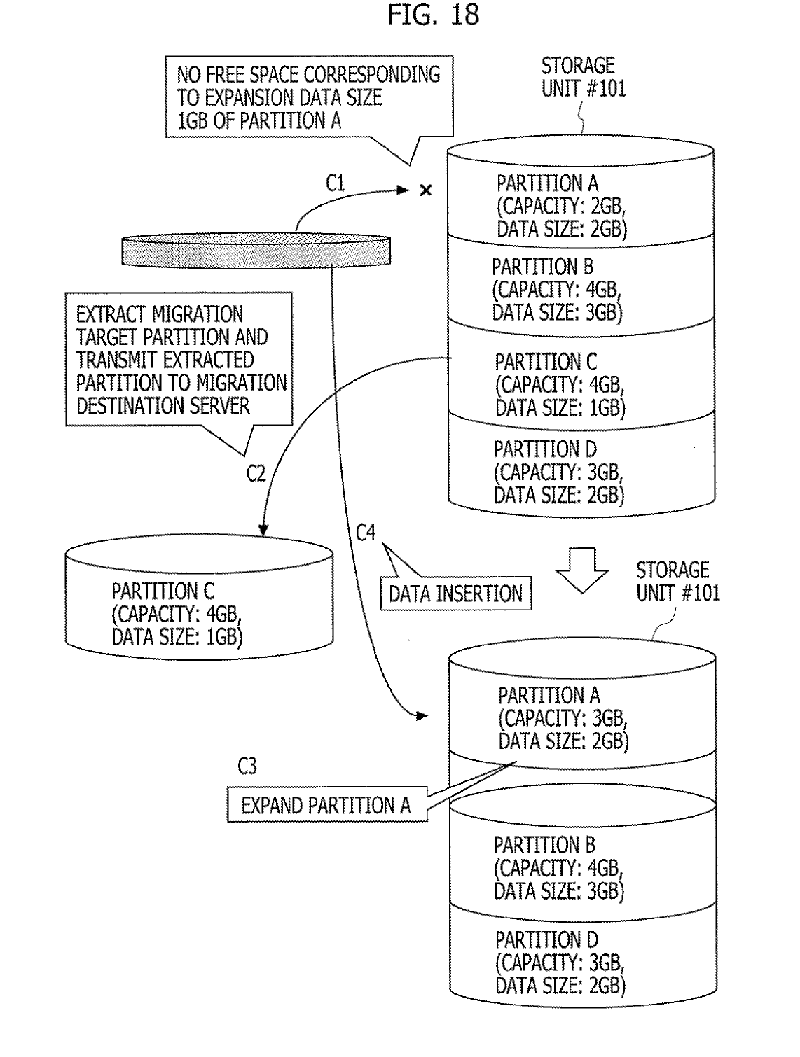

FIG. 18 is a diagram illustrating a specific example of the scale-out process. FIG. 18 illustrates details of the processes B2, B3, B4 and B6 in FIG. 17. It is assumed that the storage unit #101 is segmented into the partitions A-D.

The server #101 receives the processing request for inserting the data into the partition A from the client #2. The storage unit #101 has not free area equivalent to an expansion data size “1 GB” of the partition A, and hence the data based on the processing request is not inserted into the storage unit #101 (C1, B2 in FIG. 17). Note that the expansion data size is defined in the “expansion data size” field of the partition information list (FIG. 11).

The server #101 migrates part of the partitions of the storage unit #101 to the server #201 in order to ensure the free area for expanding the partition A in the storage unit #101. For example, the server #101 extracts, as a migration target partition, a partition, of which the data capacity is larger than the expansion data size of the partition A but the data size is smaller than those of other partitions. In the example of FIG. 18, the server #101 extracts the partition C as the migration target partition, and transmits the partition C to the migration destination server #201 (C2, B3 and B4 in FIG. 17).

The storage unit #101 can ensure the free area, and the server #101 therefore expands the data capacity of the partition A by 1 GB into 3 GB (C3). The server #101 inserts the data based on the processing request into the expanded partition A (C4).

In the example of FIG. 18, the server #101 selects the migration target partition from the partitions exclusive of the partition containing the operation target data, but the selected partition is not limited to this partition. The server #101 may migrate the partition (the partition A in FIG. 18) containing the operation target data to the migration destination server #201. The server #101 may also migrate the plurality of partitions when the free area is deficient even by migrating one partition.

<<Processing Request After Scale-Out>>

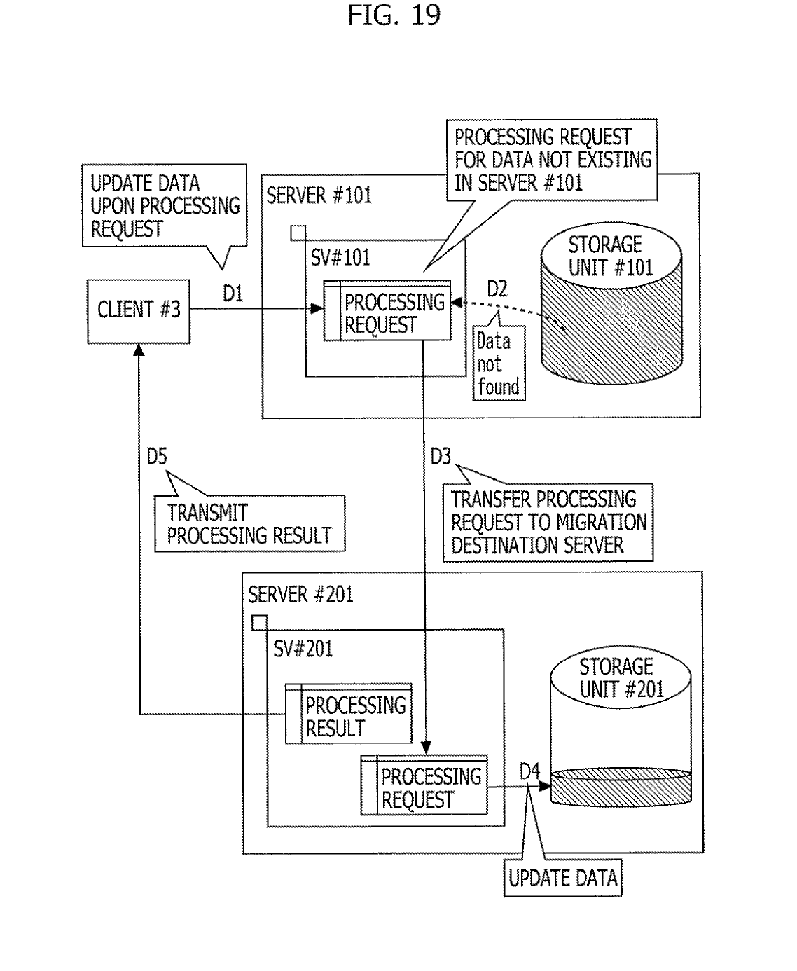

FIG. 19 is a diagram illustrating an operational example of the server apparatus 2a receiving the processing request after the scale-out. Each client apparatus 2b, when receiving the processing result from the server apparatus 2a different from the server apparatus 2a to which the processing request is transmitted, recognizes that the operation target data have been migrated by the scale-out. Accordingly, the client apparatuses 2b other than the client apparatus 2b implementing the scale-out command with respect to the server apparatus 2a, keep transmitting the processing requests to the migration source server apparatus 2a during a period till recognizing that the operation target data will have been migrated by the scale-out.

In the example of FIG. 19, the server #101 receives the processing request for updating the data from the client #3 not recognizing that the operation target data have been migrated (D1). The operation target data have been migrated to the server #201, and do not therefore exist in the storage unit #101 (D2).

The server #101 acquires the information of the server #201 as the migration destination server of the partition containing the operation target data from the partition list (FIG. 8). The server #101 transfers the processing request received from the client #3 to the server #201 (D3).

The server #201 updates the data of the storage unit #201, based on the processing request transferred from the server #101 (D4). The server #201 transmits the processing result to the client #3 (D5). The client #3 recognizes from the processing result received from the server #201 that the operation target data have been migrated to the server #201 from the server #101. The client #3 updates the information of the migration destination server of the partition containing the operation target data in the partition information list based on the data storage information contained in the processing result data.

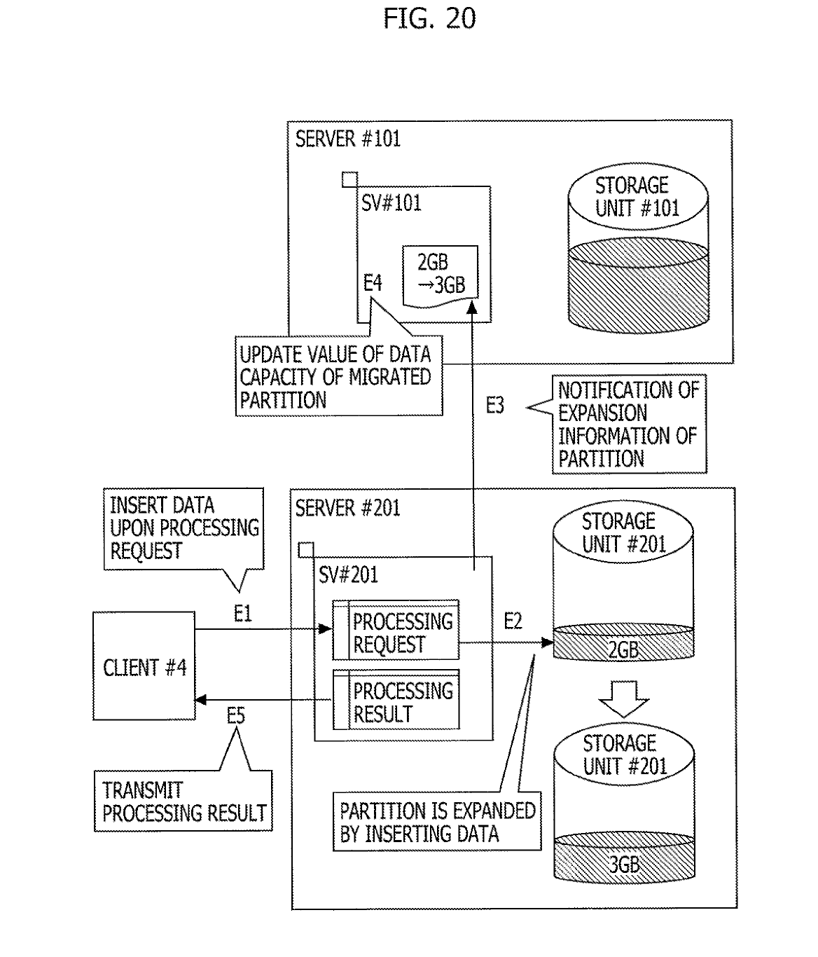

FIG. 20 is a diagram illustrating an operational example of a process of updating the data capacity of the migration data (partition), corresponding to a variation at the migration destination. The server apparatus 2a, when the overload is cancelled by the data operation based on the processing request given from the client apparatus 2b after the scale-out, returns the migration data to the self server apparatus 2a from the migration destination server apparatus 2a. A determination about whether the overload is cancelled is made depending on whether the data capacity of the free area of the storage unit #101 is larger than the data capacity of the migration data. The data capacity of the migration data varies based on the processing request given from the client apparatus 2b as the case may be. Therefore, the migration source server apparatus 2a retains and updates the data capacity of the migration data, corresponding to the variation at the migration destination.

The server #201 receives, from the client #4, the processing request for inserting the data with respect to the data migrated to the storage unit #201 from the server #101 (E1). The server #201 inserts the data into the storage unit #201 based on the processing request received from the client #4. When there is no free space in the data capacity of the partition receiving the data insertion, the data capacity of the partition is expanded. In the example of FIG. 20, the data capacity of the partition receiving the data insertion is expanded to 3 GB from 2 GB (E2).

The server #201 notifies the migration source server #101 that the data capacity of the partition has been expanded (E3). The server #101 updates a value of the data capacity of the partition migrated to the migration destination server #201 to 3 GB from 2 GB (E4). The updated value of the data capacity may be retained on, e.g., a memory (unillustrated) of the server #101.

The server #101 retains the latest data capacity of the migrated partition, and is thereby enabled to determine whether there is the free area for returning the migrated partition. The server #101 sets the latest capacity of the migrated partition in the processing result data, notifies the client apparatus 2b of this latest data capacity, and thus enables the client apparatus 2b to determine whether there is the free area for returning the migrated partition.

The server #201 sets the data storage information of the storage unit #201 in the processing result data, and transmits this processing result data to the client #4 (E5). The process in E5 may simply executed after the process in S2, and may also be sequenced before or after the processes in E3 and E4.

<Scale-Out Cancellation Process>>

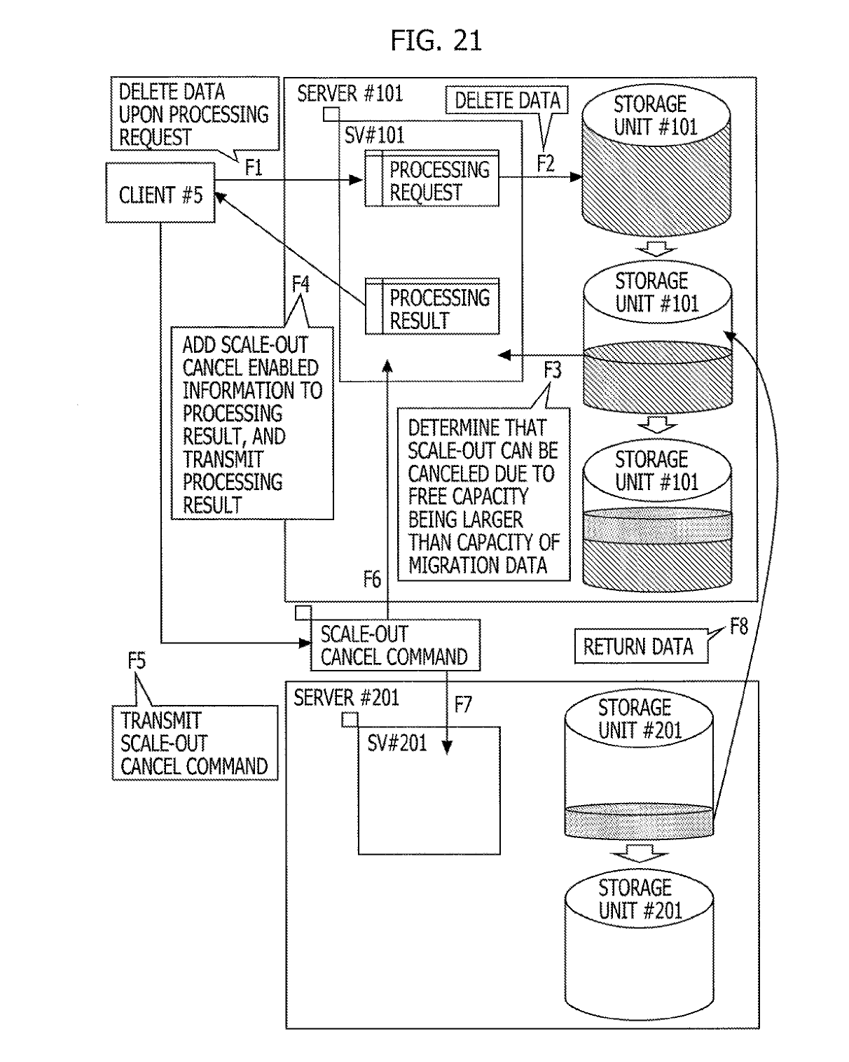

FIG. 21 is a diagram illustrating an operational example of a scale-out cancellation process. The server #101 receives a processing request for deleting the data from a client #5 (F1). The server #101 deletes the operation target data from the storage unit #101 (F2).

The server #101 acquires the data storage information from the storage unit #101. The server #101 compares a server free capacity of the data storage information with the latest data capacity of the partition migrated to the server #201. When the server free capacity is larger than the latest data capacity of the partition migrated to the server #201, it is determined that the scale-out can be cancelled (F3). Information purporting that the scale-out can be cancelled is added to the processing result data, and the processing result data is transmitted to the client #5 (F4).

The client #5 transmits a scale-out cancelation command to the server #101 and the server #201, based on the information purporting that the scale-out can be cancelled, the information being added to the processing result data (F5). The migration source server #101 and the migration destination server #201 receive the scale-out cancelation command (F6, F7).

The server #201 receiving the scale-out cancelation command returns, to the server #101, the partition containing the data migrated to the storage unit #201. The server #101 stores the returned partition in the storage unit #101 (F8).

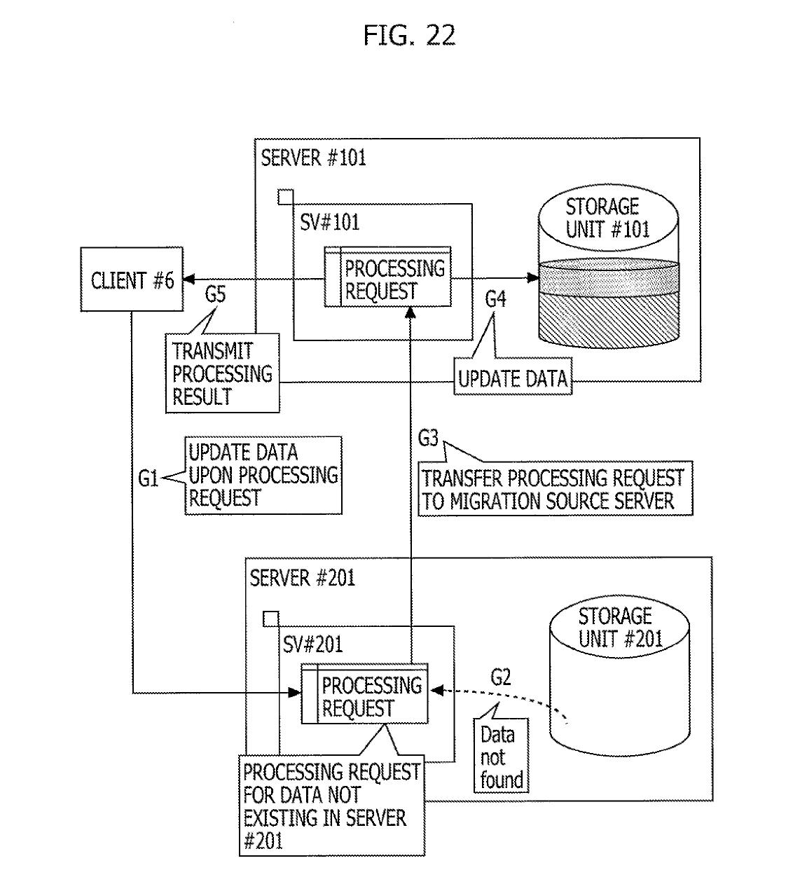

FIG. 22 is a diagram illustrating an operational example of the server apparatus 2a receiving the processing request after cancelling the scale-out. Each client apparatus 2b transmits the processing request to the scale-out destination server apparatus 2a, and, when receiving the processing result data from the server apparatus 2a different from the scale-out destination server apparatus 2a, recognizes that the operation target data have been returned to the original server apparatus 2a. Accordingly, the client apparatuses 2b other than the client apparatus 2b executing the scale-out cancelation command with respect to the server apparatus 2a, keep transmitting the processing requests to the migration destination server apparatus 2a during a period till recognizing that the operation target data will have been returned to the original server apparatus 2a by the scale-out cancellation.

In the example of FIG. 22, the server #201 receives a processing request for updating the data from a client #6 not recognizing that the operation target data have been returned to the original server apparatus 2a by the scale-out cancellation (G1). The operation target data have been returned to the server #101, and do not therefore exist in the storage unit #201 (G2).

The server #201 acquires the information of the migration source server #101 of the partition containing the operation target data from the partition list (FIG. 8). The server #201 transfers the processing request received from the client #6 to the server #101 (G3).

The server #101 updates the data of the storage unit #101, based on the processing request transferred from the server #201 (G4). The server #101 transmits the processing result data to the client #6 (G5). The client #6 recognizes from the processing result data received from the server #101 that the operation target data have been returned to the server #101 from the server #201. The client #6 deletes the information of the migration destination server of the partition containing the operation target data from the partition information list (FIG. 11), based on the data storage information contained in the processing result data.

<Processing Flow>

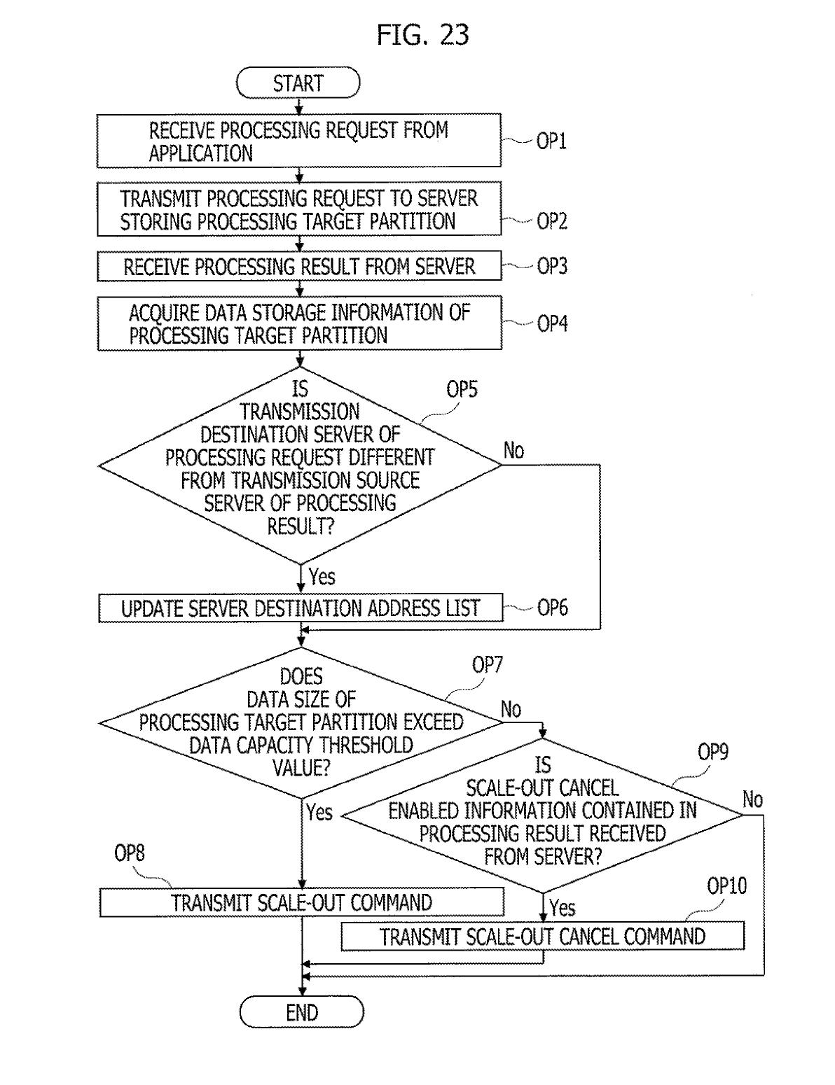

FIG. 23 is a flowchart illustrating an example of processes, in which the client apparatus 2b monitors the load on the server apparatus 2a. A start of the processes illustrated in FIG. 23 is triggered by running, e.g., the application software 60 on the client apparatus 2b.

In OP1, the client apparatus 2b receives the processing request from the application software 60. In OP2, the client apparatus 2b transmits the received processing request to the server apparatus 2a that stores the partition (which will hereinafter be termed a processing target partition) containing the operation target data. The process in OP2 is one example of a process of “transmitting a processing request to a second information processing apparatus including a storage unit”.

In OP3, the client apparatus 2b receives a processing result in response to the transmitted processing request from the server apparatus 2a. The process in OP3 is one example of a process of “receiving a processing result containing a data size, calculated by the second information processing apparatus, of the storage unit”.

In OP4, the client apparatus 2b acquires the data storage information of the processing target partition from the received processing result data. In OP5, the client apparatus 2b determines whether the transmission destination server of the processing request is different from the transmission source server of the processing result data. When the transmission destination server of the processing request is different from the transmission source server of the processing result data (OP5: Yes), the processing advances to OP6. Whereas when the transmission destination server of the processing request is identical with the transmission source server of the processing result data (OP5: No). The processing diverts to OP7.

In OP6, the client apparatus 2b updates the server destination address list. To be specific, the client apparatus 2b associates the partition containing the operation target data with the transmission source server of the processing request data.

In OP7, the client apparatus 2b determines whether the data size of the processing target partition exceeds the data capacity threshold value. For example, when the data capacity threshold value is 90%, it may be simply determined whether the data size of the processing target partition exceeds 90% of the data capacity that can be stored in the partition. When the data size of the processing target partition exceeds the data capacity threshold value (OP7: Yes), the processing advances to OP8. Whereas when the data size of the processing target partition does not exceed the data capacity threshold value (OP7: No), the processing diverts to OP9. The process in OP7 is one example of a process of “determining whether the data size, contained in the received processing result, of the storage unit exceeds a predetermined size”.

In OP8, the client apparatus 2b transmits the scale-out command to the migration source/destination server apparatuses 2a, thereby finishing the processes illustrated in FIG. 23. The process in OP8 is one example of a process of “instructing the second information processing apparatus and the third information processing apparatus to migrate an area containing part of data stored in the storage unit to the third information processing apparatus”.

In OP9, the client apparatus 2b determines whether the processing result data received from the server apparatus 2a contains information indicating that the scale-out command can be cancelled. The determination about whether the scale-out command can be cancelled is made by the server apparatus 2a, depending on whether the free capacity of the scale-out related migration source server apparatus 2a is larger than the data capacity of the partition migrated to the migration destination server apparatus 2a. When the processing result data received from the server apparatus 2a contains the information indicating that the scale-out command can be cancelled (OP9: Yes), the processing advances to OP10. Whereas when the processing result data received from the server apparatus 2a does not contain the information indicating that the scale-out command can be cancelled (OP9: No), the processes illustrated in FIG. 23 come to an end.

In OP10, the client apparatus 2b transmits the scale-out cancel command to the migration source/destination server apparatuses 2a, and the processes illustrated in FIG. 23 are finished. The process in OP10 is one example of a process of “instructing the second information processing apparatus and the third information processing apparatus to return the area to the second information processing apparatus”.

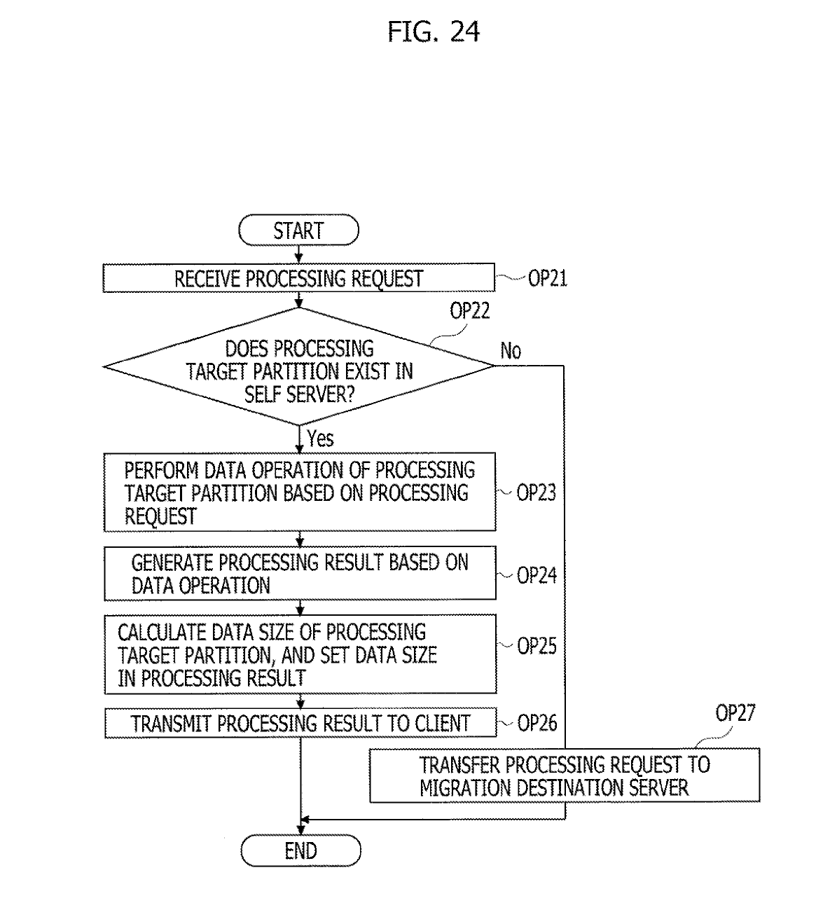

FIG. 24 is a flowchart illustrating an example of processes in such a case that the server apparatus 2a receives the processing request from the client apparatus 2b. A start of the processes illustrated in FIG. 24 is triggered by an event that the server apparatus 2a receives the processing request from the client apparatus 2b.

In OP21, the server apparatus 2a receives the processing request from the client apparatus 2b. The process in OP21 is one example of a process that “the second information processing apparatus receives the processing request transmitted from the first information processing apparatus”.

In OP22, the server apparatus 2a determines whether the processing target partition is disposed in the self server apparatus 2a. When the processing target partition is disposed in the self server apparatus 2a (OP22: Yes), the partition of the server apparatus 2a is not yet scaled out, and the processing advances to OP23. Whereas when the processing target partition is not disposed in the self server apparatus 2a (OP22: No), the partition of the server apparatus 2a is already scaled out, and the processing diverts to OP27.

In OP23, the server apparatus 2a manipulate the data contained in the processing target partition based on the processing request given from the client apparatus 2b. In OP24, the server apparatus 2a generates the processing result data based on the data operation.

In OP25, the server apparatus 2a calculates the data size of the processing target partition. The data storage information containing the calculated data size and other equivalent items is set in the processing result data. The process in OP25 is one example of a process of “calculating a data size of the storage unit after the write process, and setting the calculated data size of the storage unit in the processing result”.

In OP26, the server apparatus 2a transmits the processing result data to the client apparatus 2b, and the processes illustrated in FIG. 24 come to an end. The process in OP26 is one example of a process of “transmitting the processing result to the first information processing apparatus”.

In OP27, the server apparatus 2a transfers the processing request to the migration destination server apparatus 2a in which to dispose the partition containing the operation target partition, and the processes illustrated in FIG. 24 are finished. Note that the information of the migration destination server in which to dispose the partition containing the operation target partition, can be acquired from the partition list.

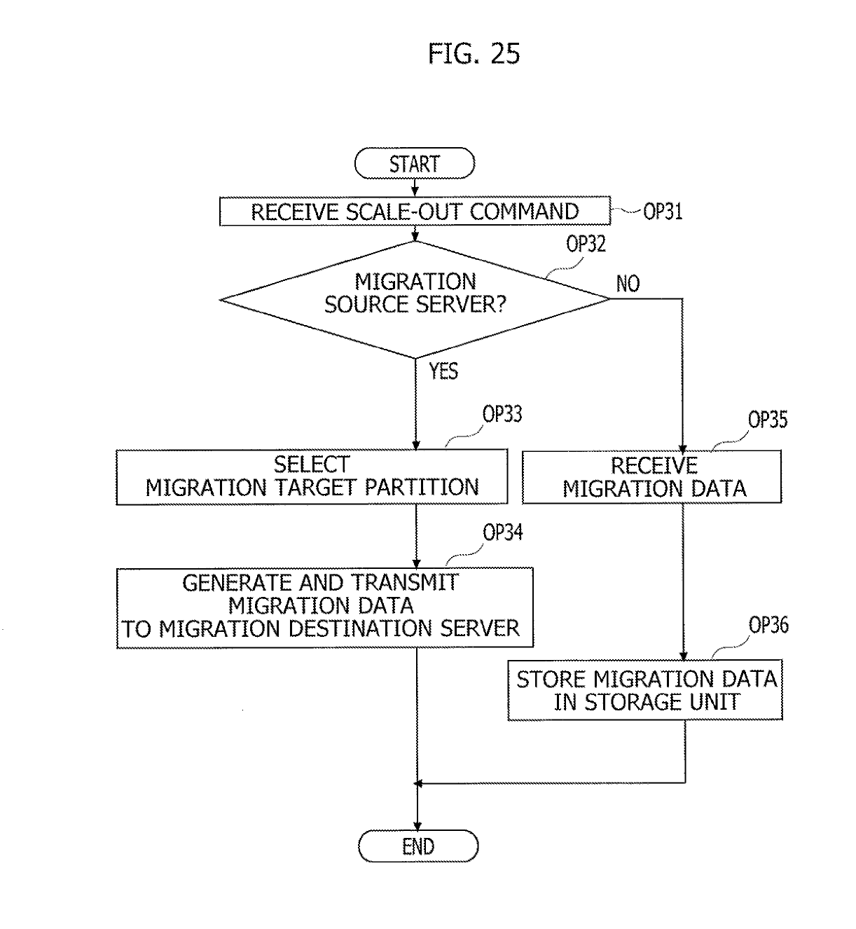

FIG. 25 is a flowchart illustrating an example of the scale-out process of the server apparatus. A start of the scale-out process is triggered by an event that the server apparatus 2a receives the scale-out command from the client apparatus 2b.

In OP31, the server apparatus 2a receives the scale-out command from the client apparatus 2b. In OP32, the server apparatus 2a determines whether the self apparatus is a migration source server. When the self apparatus is the migration source server (OP32: Yes), the processing advances to OP33. Whereas when the self apparatus is not the migration source server (OP: No), the processing diverts to OP35.

In OP33, the server apparatus 2a selects the partition that is migrated to the migration destination server apparatus 2a by the scale-out. In OP34, the server apparatus 2a generates migration data, and transmits the generated migration data to the migration destination server apparatus 2a, thereby finishing the scale-out process.

In OP35, the server apparatus 2a is the migration destination server apparatus 2a, and the migration data is received from the migration destination server apparatus 2a. In OP36, the server apparatus 2a stores the migration data in the storage unit 40a, and the processes illustrated in FIG. 25 are finished.

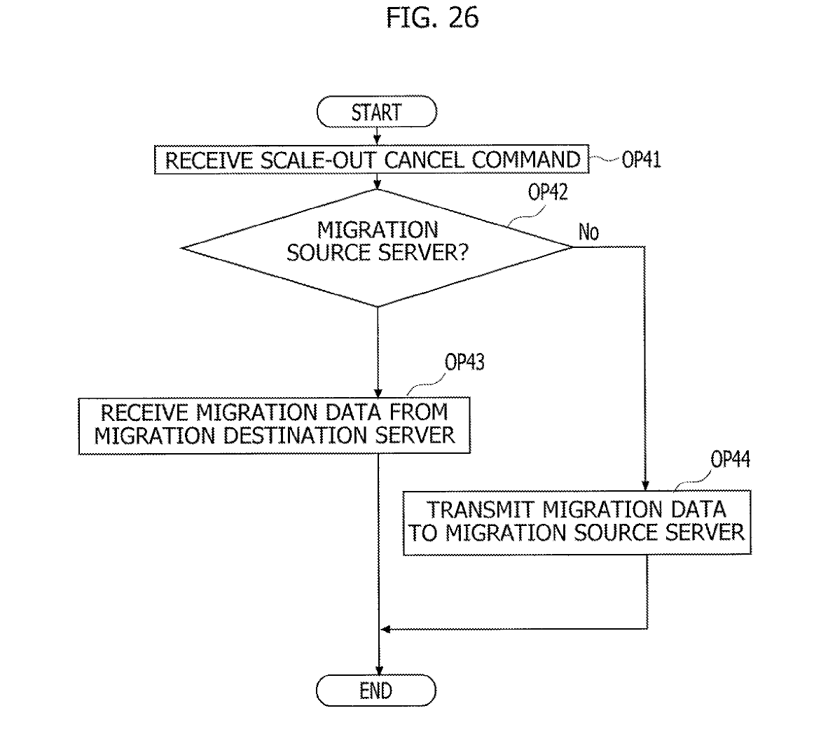

FIG. 26 is a flowchart illustrating an example of a scale-out cancel process. A start of the scale-out cancel process is triggered by an event that the server apparatus 2a receives the scale-out cancel command.

In OP41, the server apparatus 2a receives the scale-out cancel command from the client apparatus 2b. In OP42, the server apparatus 2a determines whether the self apparatus is a migration source server. When the self apparatus is the migration source server (OP42: Yes), the processing advances to OP43. Whereas when the self apparatus is not the migration source server (OP42: No), the processing diverts to OP44.

In OP43, the server apparatus 2a receives the migration data from the migration destination server apparatus 2a, and the scale-out cancel process comes to an end. In OP44, the server apparatus 2a generates the migration data and transmits the generated migration data to the server apparatus 2a, thereby finishing the scale-out cancel process.

### Operational Effect of Embodiment

The server apparatus 2a, upon receiving the processing request from the client apparatus 2b, performs the operation based on the processing request. The server apparatus 2a sets the data storage information in the processing result data of the executed processes, and transmits the processing result data to the client apparatus 2b. The client apparatus 2b determines, based on the processing result data received from the server apparatus 2a, whether the data size of the storage unit 40a or of the processing target partition exceeds the predetermined size, thereby detecting the overload on the server apparatus 2a. In other words, the client apparatus 2b detects the overload on the information processing apparatus in the process of transmitting and receiving the processing request and the processing result data to and from the server apparatus 2a. It is thereby feasible to reduce a monitoring burden and to detect the overload on the server apparatus 2a at a proper time.

The client apparatus 2b, upon detecting the overload on the server apparatus 2a, migrates the partition containing part of the data stored in the storage unit 40a to the migration destination server apparatus 2a. The loads on the server apparatuses 2a are thereby distributed without interrupting the services.

The client apparatus 2b receives the notification purporting that the data capacity of the free area of the storage unit 40a is larger than the data capacity of the partition migrated by the scale-out in the processing result data received from the server apparatus 2a, and transmits the scale-out cancel command. The scale-out cancel command is transmitted to the migration source/destination server apparatuses 2a. With the scale-out being cancelled, the migrated partition is returned to the migration source server apparatus 2a. The server apparatus 2a is thereby enabled to use the storage unit 40a at high efficiency.

### Modified Example

In the embodiment, the client apparatus 2b detects the overload on the server apparatus 2a, and instructs the server apparatus 2a to undergo the scale-out. On the other hand, in a modified example, the server apparatus 2a detects that the self apparatus is in the overload state, and implements the scale-out. The server apparatus 2a, upon detecting that the overload is obviated, cancels the scale-out.

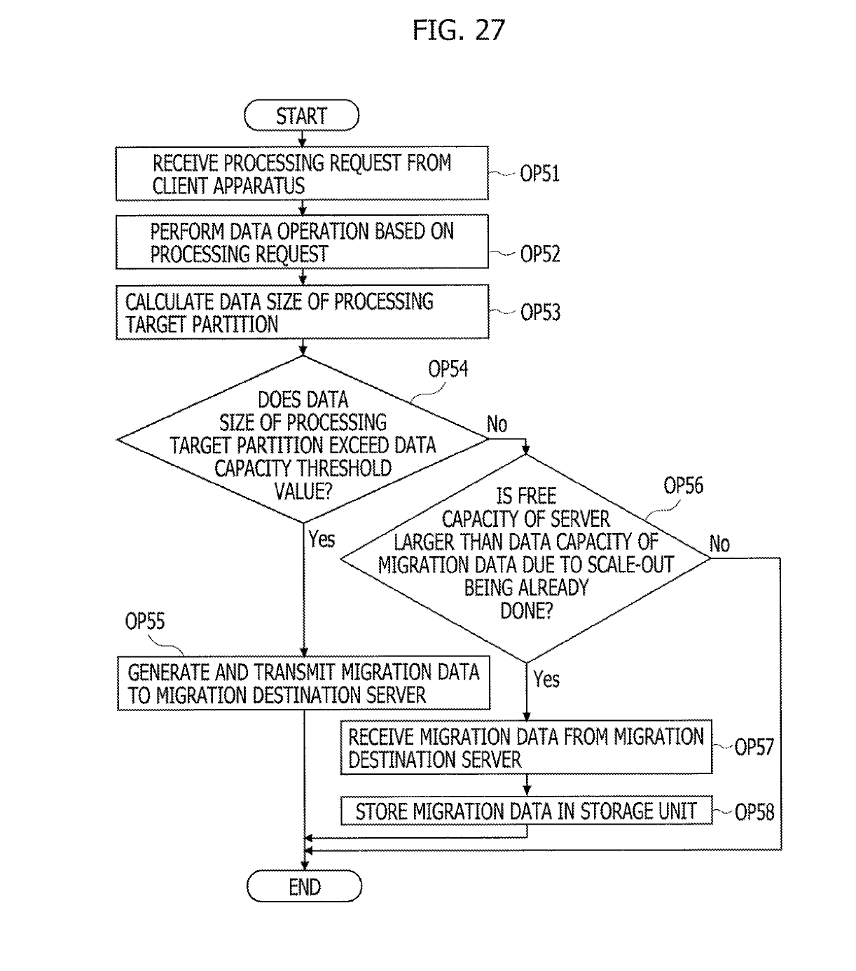

FIG. 27 is a flowchart illustrating an example of processes of monitoring the load on the self apparatus. A start of the processes illustrated in FIG. 27 is triggered by an event that the server apparatus 2a receives the processing request from the client apparatus 2b.

In OP51, the server apparatus 2a receives the processing request from the client apparatus 2b. The process in OP51 is one example of a process of “receiving the processing request transmitted by the first information processing apparatus”.

In OP52, the server apparatus 2a executes the data operation, based on the received processing request, about the partition containing the operation target data. When the data operation includes a write process, the data size of the processing target partition increases. While on the other hand, when the data operation includes a delete process, the data size of the processing target partition decreases.

In OP53, the server apparatus 2a calculates the data size of the processing target partition. The process in OP53 is one example of a process of “calculating the data size of the storage unit after the write process”.

In OP54, the server apparatus 2a determines whether the data size of the processing target partition exceeds the data capacity threshold value. The data capacity threshold value is defined in the partition information list held by the client apparatus 2b. It may be sufficient that the server apparatus 2a acquires the data capacity threshold value of the processing target partition together with the processing request given from the client apparatus 2b. When the data size of the processing target partition exceeds the data capacity threshold value (OP54: Yes), the processing advances to OP55. Whereas when the data size of the processing target partition does not exceed the data capacity threshold value (OP54: No), the processing diverts to OP56. The process in OP54 is one example of a process of “determining whether the calculated data size exceeds a predetermined size”.

In OP55, the server apparatus 2a executes the scale-out process. To be specific, the server apparatus 2a generates the migration data to the migration target partition, and transmits the generated migration data to the migration destination server apparatus 2a. The migration target partition may also be set as a processing request target partition. The migration target partition may further be set as a partition selected based on the partition information list by the client apparatus 2b. It may be sufficient that the server apparatus 2a acquires the information of the migration target partition together with the processing request from the client apparatus 2b.

The migration destination server apparatus 2a is defined in the standby server list by being associated with the service implemented by the migration source server apparatus 2a. It may also be sufficient that the server apparatus 2a acquires the information about the migration destination server apparatus 2a together with the processing request from the client apparatus 2b. The process in OP55 is one example of a process of “migrating an area containing part of the data stored in the storage unit to the third information processing apparatus”.

In OP56, the server apparatus 2a, in which the scale-out is implemented, determines whether the free capacity of the server apparatus 2a is larger than the data capacity of the migration target partition. When the free capacity of the server apparatus 2a is larger than the data capacity of the migration target partition (OP56: Yes), the processing advances to OP57. Whereas when the free capacity of the server apparatus 2a is equal to or smaller than the data capacity of the migration data (OP56: No), the processes illustrated in FIG. 27 are finished. The process in OP56 is one example of a process of “calculating the data capacity of the free area of the storage unit after the delete process”.

In OP57, the server apparatus 2a executes the scale-out cancel process. Specifically, the migration source server apparatus 2a receives the migration data from the migration destination server apparatus 2a. In OP58, the server apparatus 2a stores the received migration data in the storage unit 40a, and the processes illustrated in FIG. 27 are finished. The processes in OP57 and OP58 are one example of a process of “returning the area migrated to the third information processing apparatus to the second information processing apparatus”.

FIG. 27 illustrates an example that the server apparatus 2a detects the overload or the obviation of the overload on the self apparatus and implements the scale-out or cancellation of the scale-out, but the modified example is not limited this example. The management server 2c, which monitors the server apparatus 2a and the client apparatus 2b, may be caused to implement the scale-out command or the scale-out cancel command. It may be sufficient that the server apparatus 2a detects the overload or the obviation of the overload on the self apparatus, and notifies the management server 2c of the overload or the obviation of the overload in order to avoid the monitoring burden on the management server 2c.

### Operational Effect of Modified Example

The data size of the storage unit 40a varies depending on the data operation by the server apparatus 2a. The server apparatus 2a determines whether the data size exceeds the predetermined size after the data operation for the storage unit 40a, and is thereby enabled to detect the overload more quickly than ever before.

The management server 2c implements the scale-out command or the scale-out cancel command based on detecting the overload or the obviation of the overload on the server apparatus 2a, and is thereby enabled to unitarily manage the items of information about the load states and the scale-outs of the respective server apparatuses 2a.

<Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM (Read-Only Memory) and other equivalent recording mediums are given as the non-transitory recording mediums fixed within the computer and other equivalent apparatuses. Further, a Solid State Drive (SSD) is also available as the non-transitory recording medium removable from the computer and other equivalent apparatuses and also as the non-transitory recording medium fixed within the computer and other equivalent apparatuses.

According to the embodiments, it is feasible to timely detect the overload on the information processing apparatus to process the processing requests transmitted by other information processing apparatuses while reducing the monitoring burden.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a load monitoring program that causes a first information processing apparatus to execute a process comprising:
transmitting a processing request to a second information processing apparatus including a storage unit;
receiving a processing result containing a data size of the storage unit, the data size of the storage unit being calculated by the second information processing apparatus; and
determining whether the data size, contained in the received processing result, of the storage unit exceeds a predetermined size.

2. The non-transitory computer-readable recording medium storing the load monitoring program according to claim 1, the process further comprising:
instructing the second information processing apparatus and a third information processing apparatus to migrate, when the data size of the storage unit exceeds the predetermined size, an area containing part of data stored in the storage unit to the third information processing apparatus.

3. The non-transitory computer-readable recording medium storing the load monitoring program according to claim 2, the process further comprising:
instructing the second information processing apparatus and the third information processing apparatus to return the area to the second information processing apparatus when receiving notification purporting that a data capacity of a free area of the storage unit is larger than the data capacity of the area migrated to the third information processing apparatus in the processing result.

4. A non-transitory computer-readable recording medium storing a load monitoring program that causes a second information processing apparatus including a storage unit to execute a process comprising:
receiving a processing request transmitted by a first information processing apparatus;
calculating a data size of the storage unit after a write process when the received processing request contains the write process to the storage unit; and
determining whether the calculated data size exceeds a predetermined size.

5. The non-transitory computer-readable recording medium storing the load monitoring program according to claim 4, the process further comprising:
migrating, when the data size of the storage unit exceeds the predetermined size, an area containing part of data stored in the storage unit to the third information processing apparatus.

6. The non-transitory computer-readable recording medium storing the load monitoring program according to claim 5, the process further comprising:
calculating, when the processing request contains a delete process from the storage unit, a data capacity of a free area of the storage unit after the delete process; and
returning the area migrated to the third information processing apparatus to the second information processing apparatus when the data capacity of the free area is larger than the data capacity of the area.

7. A load monitoring method executed by a first information processing apparatus, the load monitoring method comprising:
transmitting a processing request to a second information processing apparatus including a storage unit; and
receiving a processing result containing a data size, calculated by the second information processing apparatus, of the storage unit; and
determining whether the data size, contained in the received processing result, of the storage unit exceeds a predetermined size.

8. An information processing apparatus comprising:
a memory; and
a processor coupled to the memory and the processor configured to:
transmit a processing request to a second information processing apparatus including a storage unit;
receive a processing result containing the data size, calculated by the second information processing apparatus, of the storage unit; and
determine whether the data size, contained in the received processing result, of the storage unit exceeds a predetermined size.
